(19) United States
(12) Patent Application Publication
(10) Pub. No.: US 2005/0160259 A1
(43) Pub. Date: Jul. 21, 2005

(54) Digital certificate management system, apparatus and software program

(76) Inventors: Masaaki Ogura, Kawasaki-shi (JP); Hiroshi Kakii, Yokohama-shi (JP)

Correspondence Address: KNOBLE YOSHIDA & DUNLEAVY, LLC, Eight Penn Center, Suite 1350, 1628 John F. Kennedy Blvd., Philadelphia, PA, 19103, US

(21) Appl. No.: 11/006,356

(22) Filed: Dec. 7, 2004

Related U.S. Application Data
(63) Continuation-in-part of application No. 10/815,043, filed on Mar. 31, 2004.

(30) Foreign Application Priority Data
Mar. 31, 2003 (JP) 2003-096240
Dec. 8, 2003 (JP) 2003-08816

(51) Int. Cl. H04L 9/00

(52) U.S. Cl. 713/156

(57) ABSTRACT

The communication devices are produced with a distinct digital certificate to later identify themselves during communication with a central or remote management apparatus. The identity of the communication device guarantees that appropriate information is provided to the central management apparatus from the communication device. For example, if charge information is uploaded from the communication terminal to the central management apparatus to generate an invoice or a charge, the information should be native or germane to the original device containing the communication device. To avoid the inaccurate information, the digital certificate is confirmed according to the digital certificate at the central management apparatus prior to uploading the information.

### FIELD OF THE INVENTION

The current invention is generally related to an information management system or software program, and more particularly related to the system including an information processing device for transmitting predetermined information to a communication device and writing it to memory of the communication device and a digital certificate management device for communicating with the information processing device via a network. The current invention is also particularly related to the computer program for practicing a method of obtaining a digital certificate at the above information processing device.

### BACKGROUND OF THE INVENTION

A remote management system was proposed in the past that a remote management device at a service center remotely controls managed devices via networks such as the Internet and public lines. The managed devices include electronic devices with measuring units and communication units. The measuring units are applicable for the water, electricity and gas consumption and also applicable to air conditioning units, electrical power supply units, medical devices, automatic vending machines, the network-based consumer electronics as well as the image processing devices. Certain image processing devices includes multi-functional digital devices, scanners, digital copies, facsimiles (fax) and printers with communication capability.

On the other hand, if the managed devices do not have communication capability or the managed devices have only limited communication capability without a function to communicate with a central or remote management system, it has been proposed that an intermediate device with the communication function is connected via network and that the remote management system manages the managed devices via the network and the intermediate device.

Meanwhile, a client server system has been put together by connecting via network a plurality of computers such as personal computers at least one of which is designated as a server device and at least another one of which is designated as a client. In the above client-server system, a request is transmitted from the client to the server. In response to the request from the client, the server performs a corresponding process and transmits a response back to the client.

In the above described remote management system, the communication device or the intermediate device connected to the communication device has the client device functions while the central management device has the server device functions. When the communication device or the intermediate device is connected to the central management device via firewalls and network, the communication device or the intermediate device reports the polling results on the transmission request to the central management device. The central management device performs a handling process according to the polling results and returns a response to the communication device or the intermediate device. For example, the central management device reports to the intermediate device a charge counter obtaining request in response to the polling result from the intermediate device. Upon receiving the charge counter obtaining request from the central management device, the polling-destination intermediate device reports the charge counter obtaining request to an image forming device that is connected to the intermediate device itself. In response to the charge counter obtaining request from the intermediate device, the image forming device reads the data stored in the non-volatile memory and transmits the read data or the response data for the charge counter to the intermediate device. The intermediate device in turn transmits the charge counter data to the central management device.

In the above described situation, it is important to confirm whether the information to be transmitted is updated or whether the communication destination is proper. Furthermore, since the information is passed on the Internet frequently among computers that are not relevant before it reaches the communication destination, it is necessary to protect the secret data such as the charge counter data during the transmission. For example, one communication protocol for the above requirements is called Secure Socket Layer (SSL) that has been developed and widely used. Based upon the above protocol, by combining a public key coding method and a common key coding method, a communication partner is confirmed, and the manipulation or misappropriation of the coded data is prevented.

Referring to FIG. 36, a flow chart illustrates a communication sequence for mutually recognizing a client device and a server device based upon the SSL. The sequence will be described in detail with respect to the confirmation. The client device includes a communication device or an intermediate device while the server device includes an intermediate device. To mutually recognize based upon the SSL, it is necessary to store a route key certificate, a client private key and a client public key certificate or a client certificate at the client device. The client private key is a private key that a certificate authority (CA) has issued to a particular one of the client devices. The client public key certificate is a digital certificate that the CA has added a digital signature to the public key that corresponds to its private key. The route key certificate is a digital certificate that the CA has added a digital signature to a route key or a certificate public key (certificate key) that corresponds to the route private key which the CA uses for digital signature. It is necessary to store the route key certificate, the server private key and the server public key certificate in the server device. The server private key and server public key certificate are the corresponding ones that the CA has issued the server device. It is assumed that the same CA has issued the client device and the server device the certificate based upon the same route private key. In this case, the route key certificate is common between the client device and the server device.

Still referring to FIG. 36, steps S11 through S27 describe the process at the client and server devices. The arrows between the client and server processes indicate data transfers. A transmission side performs the transmission at the step that is located at the origin of the arrow while a reception side performs a step located at the tip of the arrow upon receiving the data information. When each step is not normally completed, the process is interrupted by returning a confirmation failure response. Upon receiving the confirmation failure response from the destination, the process is treated the same as if a time out has occurred. In the client-server system, the client device requests a connection. When the connection request is necessitated by a user instruction, the client device CPU initiates by executing a necessary control program a process in the left side of the flow chart in FIG. 36. On the other hand, upon receiving the connection request, the server device CPU initiates by executing a necessary control program a process in the right side of the flow chart in FIG. 36.

In the step S11, a connection request is transmitted from the client device to the server device. The server process at the step S21 receives the request and generates a random number. The step S21 further codes the generated random number based upon a predetermined server private key. In the step S22, the server process transmits the coded first random number and the server public key certificate to the client process. In the step S22, the server device CPU functions as a first server confirmation processing means. In the step S12, upon receiving the transmission, the client process confirms the authenticity of the server public key certificate based upon a route certificate. In the authentication process, not only it is confirmed that the certificate has experienced damage or alteration, but also it is confirmed that the server device is a proper communication device based upon the reference information. Following the confirmation, the client process in the step S13 decodes the coded first random number by the server public key contained in the server public key certificate. After a successful decoding step, it is confirmed that the first random number is indeed received from the server device that has been issued the server public key certificate. Thus, the server device is confirmed as a proper communication destination. In the above steps S12 and S13, the client device CPU functions as a second client confirmation processing means.

The client process in the step S14 now generates a second and third random numbers. The client process in the step S15 then codes the second random number based upon the client private key and the third random number based upon the server public key. The client process in the step S16 transmits the above coded second and third numbers with the client public key certificate to the server process. The third random number coding is performed to avoid the random number value to be known to devices other than the server device. In the above step S16, the client device CPU functions as a first client confirmation processing means. Upon receiving the transmitted data, the server process in the step S23 confirms the authenticity of the client public key certificate based upon the route key certificate. As similarly in the step S12, the step S23 includes a confirmation that the client device is a proper communication partner. After the confirmation, the server process in the steps S24 and S25 now decodes the second and third coded random numbers respectively based upon the client public key and the server private key. In the above steps S23 and S24, the server device CPU functions as a second confirmation processing means. At least, the third random number is not know to other devices except for the client device that has generated it and the server device having the server private key. Upon successful decoding, the server process returns a success response to the client process in the step S26. Upon receiving the response at the client device, the client process generates a common key based upon the first, second and third random numbers in the step S17 and subsequently uses the common key for coding. The client process then terminates. The server process generates a common key based upon the first, second and third random numbers in the step S27 and subsequently uses the common key for coding. The server process then terminates. The server and client devices utilizes the common key that is generated in the step S17 or S27 in order to communicate with each other by coding the data according to the common key coding method. Consequently, the server and client devices safely exchange the common key after confirming each other in order to communicate with the confirmed partner.

Now referring to FIG. 37A, a diagram illustrates components of the client public key. The client public key includes a key body for decoding documents that have been coded by a client private key as well as reference information on the issuing CA for the public key, the client device that has been issued the public key and the expiration date. The CA adds the client public key a digital signature that is a coded hash value from the client public key based upon a route private key. The identification information of the route private key to be used for the digital signature is added to the reference information of the public key. The public key certificate with the digital signature is the client public key certificate. When the client public key certificate is used for confirmation, the digital signature is decoded using the key body of the route key that corresponds to the route private key. If the decoding process is performed successfully, it is confirmed that the digital signature is added by the CA. Furthermore, if the hash value obtained from the client public key portion matches the hash value from the decoding process, it is also confirmed that the key itself is free from damage or alteration. If the received data is successfully decoded based upon the client public key, it is confirmed that the data has been transmitted from the client device who owns the client private key. Subsequently, it is determined whether or not confirmation is finalized by referring to the reference information such as the CA credibility and the registration of the client device.

Now referring to FIG. 37B, a diagram illustrates components of the route key. It is necessary in advance to store the route key in the route key certificate in which the CA has added a digital signature. The route key certificate is a self-signed format by decoding the digital signature with the public key contained in itself. When the route key is used, the digital signature is decoded by the key body that is contained in the route key certificate. The hash value is obtained by hashing the route key and is then compared. If the hash value matches, it is confirmed that the route key is free from damage or alteration.

In the above described remote management system, in order for a communication device to communicate with the central management device through the SSL for the mutual recognition, it is also necessary in advance to store in the internal memory the digital certificates that include the route key certificate, the client private certificate and the client public key certificate. The digital certificate is obtained from the CA. For example, the Japanese Patent Publication 2001-325249 discloses one way of obtaining the digital certificates. It is desired among communication devices and management devices in the above remote management system to distinguish communication devices that have been licensed with a sales company and to remotely manage only those communication devices.

The communication device to be used in the remote management system is produced by a predetermined daily number for each device model. It is determined whether or not the digital certificate is stored in the internal memory of each device model. That is, it is determined whether or not the communication device responds to the remote management by the central remote management device. Since the communication devices are not produced based upon a certain order, it is not possible that the communication devices are produced with the internal memory storing the digital certificates after a conservative license agreement is made. For this reason, even if a license agreement has not been made, it has been proposed that the communication devices store the digital certificate in the internal memory unit, and the communication devices are initialized by a predetermined operation after a license agreement for being later remotely managed by the management device.

In adapting the above proposed method, one way for the remote management system to obtain from a communication device a device type number and a serial number in order to determine whether or not a given communication device is under the license agreement. On the other hand, the identification information is not placed in the digital certificate, and a common certificate is used for the same device type. In this case, after certifying a communication device as a bona fide communication partner based upon the digital certificate, the identification information is obtained from the communication device to determine whether or not the communication device is under the license agreement. Unfortunately, there is a problem that a user may illegally copy the common device number to another unlicensed communication device. For example, a user owns one licensed device and one unlicensed device and both devices locally keep track of the account value for a predetermined service or goods to be provided to a user. If the account value of the unlicensed device value is smaller than that of the licensed device, it is possible for the user to copy the device number from the licensed device to the unlicensed device in order to inappropriately reduce the payment amount by communicating with the remote management device from the unlicensed device. Because the remote management device cannot distinguish an unlicensed communication device and determines the account value based upon the counter information from the unlicensed device, the remote management device changes the lower price.

To generate the digital certificate for the communication device at a factory, the placement is performed via the factory production facility. Because of the above setting where a large number of communication devices is produced everyday, if the digital certificate is compromised from the factory, the leak will cause a significant effect on the large number of the communication devices. Thus, security is a major issue.

For the above reasons, the current invention provides a communication device that is not easily converted into a fake licensed communication device and also reduces the security effect even if the digital certificate is compromised from the production facility.

### SUMMARY OF THE INVENTION

In order to solve the above and other problems, according to a first aspect of the current invention.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a conceptual diagram illustrating a first example of the construction of the remote management system according to the current invention.

FIGS. 2A and 2B are conceptual diagrams illustrating data transmission and reception models of the above-mentioned transmission and reception.

FIG. 3 is a conceptual diagram illustrating a preferred embodiment of the image forming apparatus management system according to the current invention.

FIG. 4 is a conceptual diagram illustrating a second example of the construction of the remote management system according to the current invention.

FIG. 5 is a block diagram illustrating a preferred embodiment of the physical construction of the image forming apparatus according to the current invention.

FIG. 6 is a table illustrating an exemplary content of the non-volatile random access memory (NVRAM) to be used with the current application.

FIG. 7 is a block diagram illustrating an example of the software configuration of the image forming apparatus according to the current invention.

FIG. 8 is a functional block diagram illustrating one preferred embodiment of the modules of the NRS according to the current invention.

FIG. 9 is a block diagram illustrating an example of the components of the central management apparatus according to the current invention.

FIG. 10A is a block diagram illustrating the authenticate information that the image forming device stores according to the current invention.

FIG. 10B is a block diagram illustrating the authenticate information that the intermediate device stores according to the current invention.

FIG. 11 is a block diagram illustrating the authenticate information that the management device stores and utilizes for the authentication process according to the current invention.

FIG. 12 is a block diagram illustrating components in one example of the image forming device individual certificate set according to the current invention.

FIG. 13 is an exemplary format illustrating the public key certificate according to the current invention.

FIG. 14 is an exemplary content illustrating for the public key certificate according to the current invention.

FIG. 15 is a timing diagram illustrating the operation of the image forming device management system according to the current invention.

FIG. 16 is a flow chart illustrating steps involved in a preferred process of demodulating the digital signature according to the current invention.

FIG. 17 is a block diagram illustrating components of the factory in a preferred embodiment according to the current invention.

FIG. 18 is a block diagram illustrating components of the certificate management device in the preferred embodiment according to the current invention.

FIG. 19 is a block diagram illustrating hardware components of the communication terminal in the preferred embodiment according to the current invention.

FIG. 20 is a block diagram illustrating hardware components of the factory terminal 160 in the preferred embodiment according to the current invention.

FIG. 21 is a block diagram illustrating peripheral devices around the communication terminal and the factory terminal at the production factory according to the current invention.

FIG. 22 is a diagram illustrating the exemplary connections among the factory terminal, the barcode reader and the image-forming device according to the current invention.

FIG. 23 is a diagram illustrating one exemplary rated inscription plate attached to the image forming device according to the current invention.

FIG. 24 is a diagram illustrating exemplary production steps of producing the communication device at the first, second and third production lines at the production factory E of FIG. 21.

FIG. 25 illustrates an exemplary pseudo timing chart or sequence at the related devices for obtaining certificates for the image forming device management system according to the current invention.

FIG. 26A is a table illustrating the exemplary database content for the certificate management device list.

FIG. 26B is a table illustrating the exemplary database content for the daily production plan.

FIG. 27 is a table illustrating exemplary contents of the certificate database in the HDD of the communication terminal according to the current invention.

FIG. 28 illustrates exemplary contents and the data formats to be used for communicating between the communication terminal and the certificate management device according to the current invention.

FIG. 29 illustrates exemplary contents in the SOAP request to be used for communicating according to the current invention.

FIGS. 30A and 30B illustrate exemplary contents in the SOAP response for communicating between the communication device such as the image forming apparatus and the factory terminal according to the current invention.

FIG. 31 is a diagram illustrating an exemplary data format for the communication between the communication terminal 150 and the factory terminal for the above described process according to the current invention.

FIG. 32 is a diagram illustrating an exemplary data format for the communication between the image forming device and the factory terminal for the above described process according to the current invention.

FIG. 33 illustrates a remote management system includes the above described devices and units as managed devices based upon the remote system as shown in FIG. 1.

FIG. 34 is a block diagram illustrating one alternative embodiment of the communication device production factory and the related facility for installing the digital certificates according to the current invention.

FIG. 35 illustrates a flow or steps involved in the related process of installing the individual certificates by the relevant devices, and the sequence as shown in FIG. 34 for the alternative embodiment corresponds to that as shown in FIG. 25 for the preferred embodiment.

FIG. 36 is a flow chart illustrating a communication sequence for mutually recognizing a client device and a server device based upon the SSL.

FIG. 37A is a diagram illustrating components of the client public key.

FIG. 37B is a diagram illustrating components of the route key.

### DETAILED DESCRIPTION OF THE PREFERRED EMBODIMENT(S)

Based upon incorporation by external reference, the current application incorporates all disclosures in the corresponding foreign priority documents JPAP2003-096240 and JPAP 2003-08816 from which the current application claims priority.

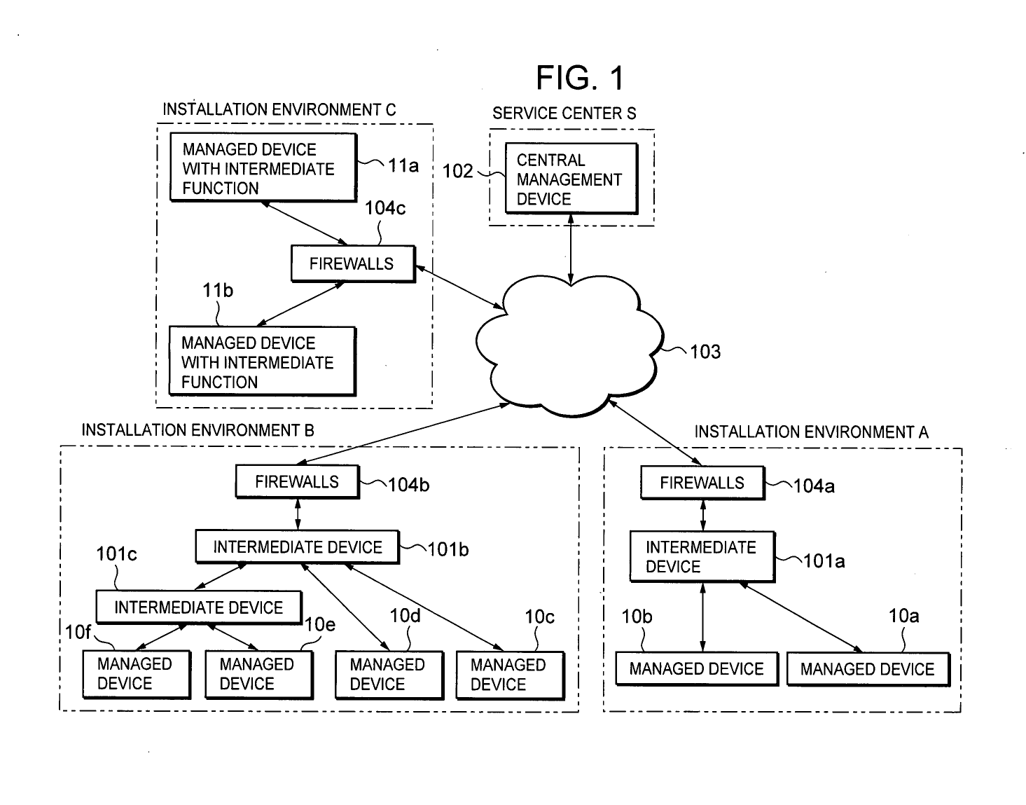

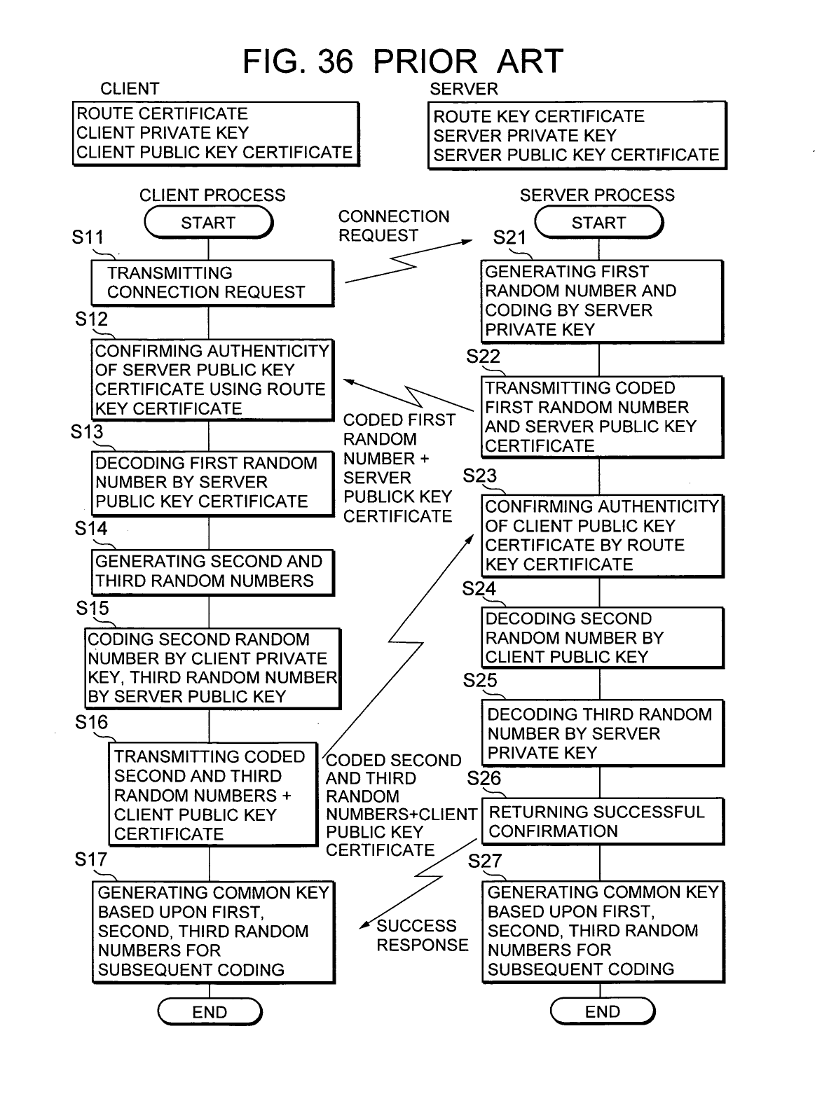

Referring now to the drawings, wherein like reference numerals designate corresponding structures throughout the views, and the following FIGS. 1 through 31 describe exemplary components of the remote management system for the managed devices such as communication devices based upon the digital certificates using a certificate setting system or a certificate handling system. The digital certificates include a key with a digital signature that is to be used in the public key infrastructure (PKI) as shown in FIG. 36. Referring in particular to FIG. 1, a conceptual diagram illustrates an example of the construction of the remote management system. The remote management system manages managed apparatuses 10 (10a, 10b, 10c, 10d, 10e, and 10f), which are image forming apparatuses such as a printer, a FAX apparatus, a digital copying apparatus, a scanner and a digital multi-functional apparatus, and communication apparatuses or electronic apparatuses such as network-based home appliances, automatic vending machines, medical equipment, power supply equipment, air conditioning systems and measuring systems for gas, water and electricity. The remote management system includes intermediate apparatuses 101 (101a, 101b, and 101c) that serve as remote management intermediate apparatuses which are connected with the managed apparatuses 10 via a local area network (LAN) external apparatuses. The managed apparatuses 10 are connected when they are seen from the managed apparatuses 10. Further, the remote management system includes a management apparatus 102 that functions as a server connected to the intermediate apparatuses 101 via, for example, the Internet 103. An alternative network such as a public circuit may also be used. In this way, the management system 102 remotely manages each of the managed apparatuses 10 via the intermediate apparatuses 101 in a centralized manner. The intermediate apparatuses 101 and the managed apparatuses 10 form various hierarchical structures in accordance with environment in which they are used.

For example, an installation environment A as shown in FIG. 1 has a simple structure where the intermediate apparatus 101a, which can establish direct connection with the management apparatus 102 by Hyper Text Transfer Protocol (HTTP), is connected to the managed apparatuses 10a and 10b. On the other hand, in an installation environment B as shown in FIG. 1, four managed apparatuses 10 (10c, 10d, 10e, and 10f) are installed. If only one intermediate apparatus 101 is installed, the processing load becomes heavy on the apparatus. For this reason, in the installation environment B, a hierarchical structure is formed. The intermediate apparatus 101b, which can establish direct connection with the management apparatus 102 by HTTP, is connected to another intermediate apparatus 101c, and the intermediate apparatus 101c is further connected to the managed apparatuses 10e and 10f. In this case, information transmitted from the management apparatus 102 for remotely managing the managed apparatuses 10e and 10f arrives at the managed apparatus 10e or 10f via the intermediate apparatus 101b and the intermediate apparatus 101c, which is a lower level node of the intermediate apparatus 101b.

In addition, as in an installation environment C, managed apparatuses 11a and 11b have intermediate functions (hereinafter also simply referred to as “managed apparatus”). The managed apparatuses 11a and 11b having the functions of an intermediate apparatus 101 may be connected to the management apparatus 102 via the Internet 103 without an intermediate apparatus. It is also possible to further connect a managed apparatus that is equivalent to the managed apparatus 10 to the managed apparatus 11 having intermediate functions, although the diagram fails to show such an arrangement in the drawing. Further, it should be noted that firewalls 104 (104a, 104b and 104c) are installed in the respective environments A, B and C for security. In such a remote management system, the intermediate apparatuses 101 run an application program for controlling and managing the managed apparatuses 10 that are connected with the intermediate apparatuses 101.

The management apparatus 102 installs an application program for controlling and managing each of the intermediate apparatuses 101 and for further controlling and managing the managed apparatuses 10 via the intermediate apparatuses 101. Each of the nodes in the remote management system, including the managed apparatuses 10, is capable of transmitting a “request” by remote procedure call (RPC) for processing in accordance with a method of the application program installed in each node and obtaining or receiving a “response” that is the result of the requested process by the RPC. That is, the intermediate apparatuses 101 or the managed apparatuses 10 connected thereto are generating a request to the management apparatus 102, transmitting the request to the management apparatus 102, and obtaining the response to the request. Similarly, the management apparatus 102 is generating a request, transmitting the same to the intermediate apparatuses 101 and obtaining the response to the request. The above requests include a request for causing the intermediate apparatuses 101 to transmit various other requests to the managed apparatuses 10 and to obtain responses from the managed apparatuses 10 via the intermediate apparatuses 101. Furthermore, in order to implement the RPC, well known communication protocols, techniques, specifications and the like are used and include SOAP (Simple Object Access Protocol), HTTP, FTP (File Transfer Protocol), COM (Component Object Model), and/or CORBA (Common Object Request Broker Architecture).

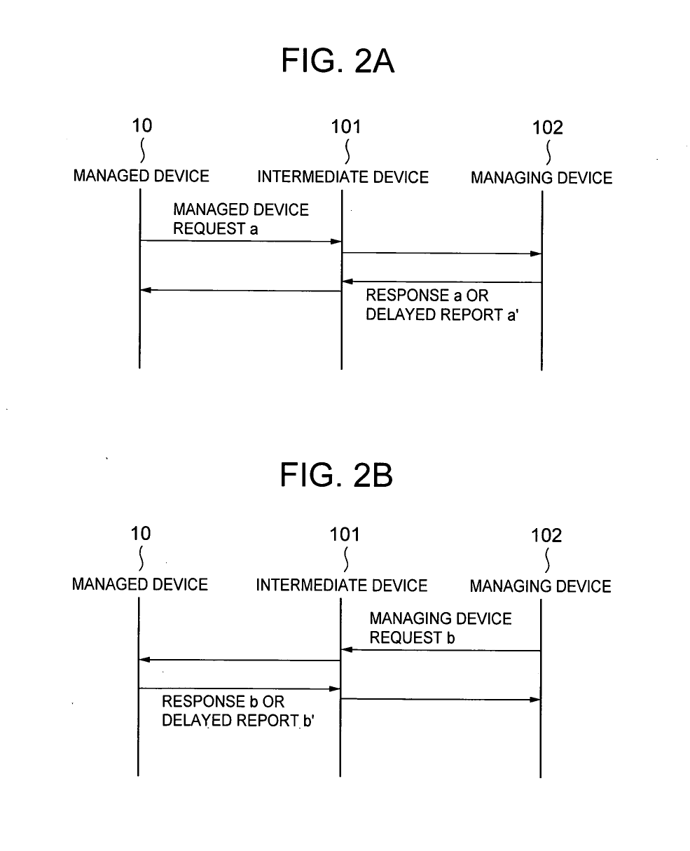

FIGS. 2A and 2B are conceptual diagrams illustrating data transmission and reception models of the above-mentioned transmission and reception. No firewalls 104 are considered in the conceptual diagrams. FIG. 2A illustrates a case where a request to the management apparatus 102 is generated at one of the managed apparatuses 10. The model in this case is as follows: the managed apparatus 10 generates a “request from the managed apparatus a”, and the management apparatus 102, receiving the request via the intermediate apparatus 101, returns a “response a.” It should be noted that FIG. 2A shows the case where a “response delay notification a′” is returned in addition to the “response a.” This is because the management apparatus 102 is configured such that, when it is determined that the response to the request cannot be returned immediately in response to reception of the “request from the managed apparatus” via the intermediate apparatus 101, the response delay notification is transmitted and the connection is temporarily disconnected. The response to the request is then given later in a subsequent connection.

FIG. 2B illustrates a case where a request to the managed apparatus 10 is generated by the management apparatus 102. The model in this case is as follows: the management apparatus 102 generates a “request from the management apparatus b”, and the managed apparatus 10 which receives this request via the intermediate apparatus 101 returns a “response b.” In addition, similar to the case of FIG. 2A, in the case of FIG. 2B, a “response delay notification b′” is returned when the response cannot be returned immediately. Next, a brief description will be given for an exemplary embodiment of the management apparatus 102 as shown in FIG. 1. The management apparatus 102 is constructed of a control device such as a file server, a modem and an external interface I/F, a CPU, a ROM, a RAM, a non-volatile memory, and the like. A detailed description of the construction will be given later. Additionally, a brief description will be given for an exemplary embodiment of the intermediate apparatus 101 as shown in FIG. 1. The intermediate apparatus 101 is constructed of a CPU, a ROM, a RAM, a nonvolatile memory, a network interface card (NIC) and the like. A detailed description of the construction will be given later.

Further, for the managed apparatus 11 having intermediate functions, the above-mentioned units or components may be simply added to the managed apparatus 10 so as to realize the functions of the intermediate apparatus 101. However, it is also possible to realize the functions of the intermediate apparatus 101 by using hardware resources provided to the managed apparatus 10, such as a CPU, a ROM, a RAM and the like, and causing the CPU to execute an appropriate application or a program module. Next, a description will be given for an image forming apparatus management system according to the present invention. The remote management system has an image forming apparatus or electronic apparatus as the managed apparatus. Such image forming apparatus is a more specific example of the communication device in which the digital certificate is installed according to the current invention.

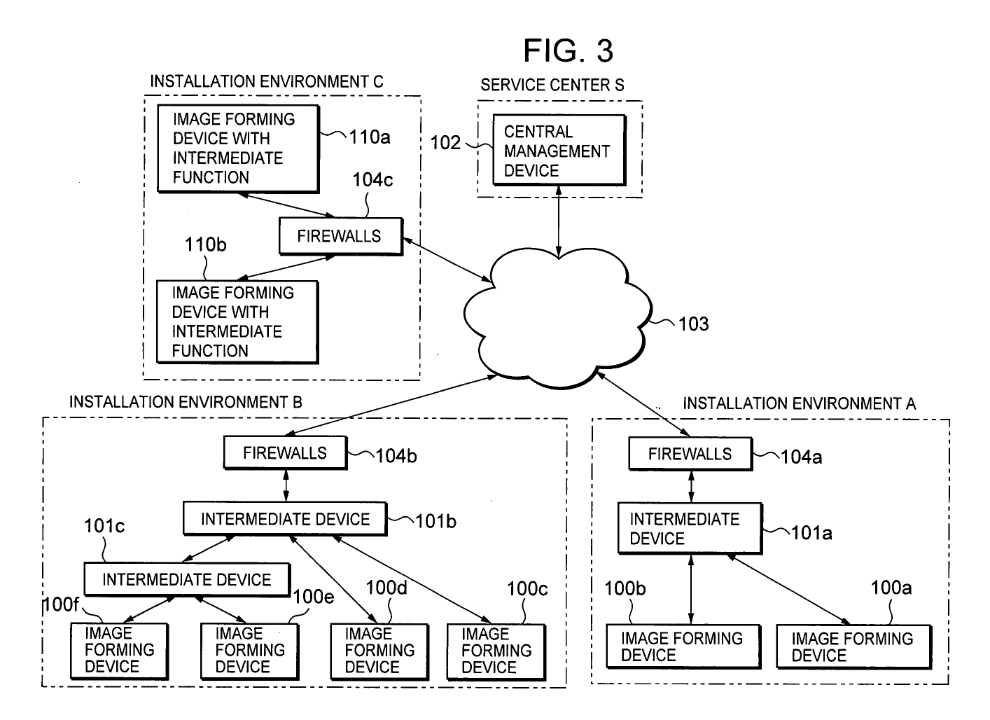

FIG. 3 is a conceptual diagram illustrating a preferred embodiment of the image forming apparatus management system according to the current invention. A description of the structure of the system will be given only to the extent that FIG. 3 differs from FIG. 1 in that the managed apparatuses 10 are changed to image forming apparatuses 100 and the managed apparatuses 11 with intermediate functions are changed to image forming apparatuses 110 having intermediate functions (hereinafter also referred to as “image forming apparatuses”). The central management device 102 is located in a service center S, where the vender service is provided for the image-forming device remote management system. The image forming apparatuses 100 are digital multi-functional apparatuses having functions of devices such as a copying machine, facsimile apparatus, scanner, and the like and functions for communicating with an external apparatus. The image forming apparatuses 100 install an application program for providing services relating to the above-mentioned functions. In addition, the image forming apparatuses 110 having the intermediate functions are the image forming apparatuses 100 having the functions of the intermediate apparatuses 101.

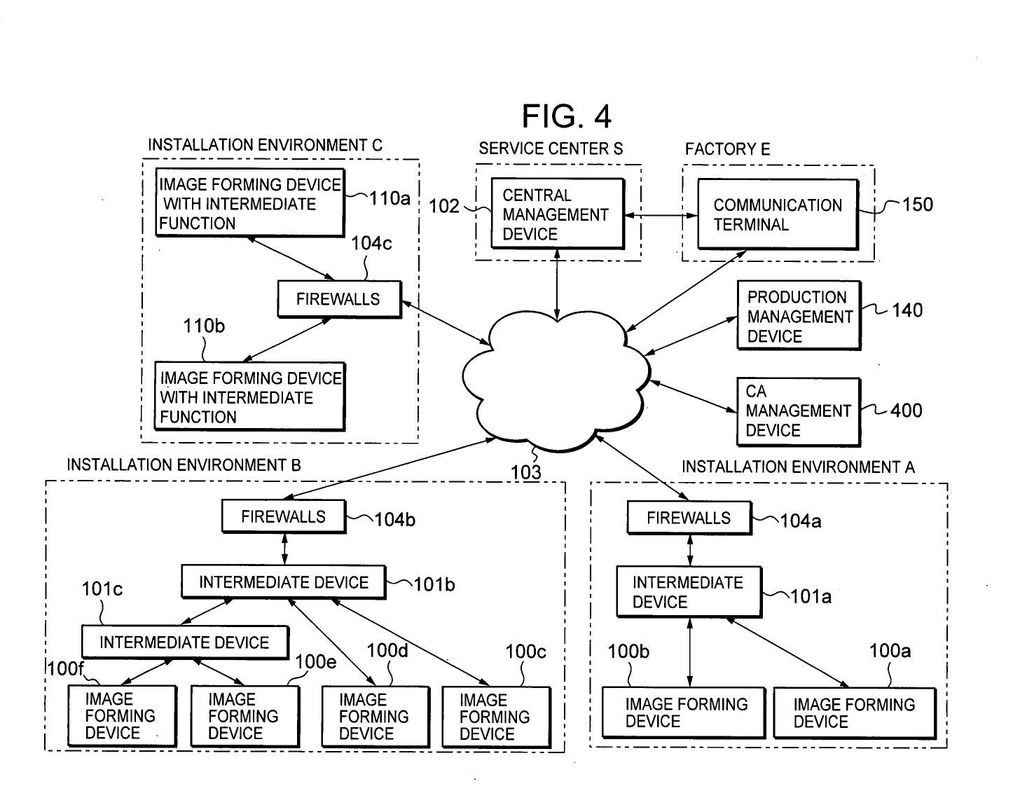

Referring to FIG. 4, a conceptual diagram illustrates a second example of the construction of the remote management system according to the current invention. The second preferred embodiment is substantially identical to the first preferred embodiment as shown in FIG. 3. The second preferred embodiment, additionally includes a communication terminal 150 at the production factory E for producing the image forming device 100, the image forming device 110 with the intermediate device function and the intermediate device 101. The second preferred embodiment also includes a production management device 140 for managing and planning production plans at the factory E. The second preferred embodiment further includes a certificate authority (CA) management device 400 for issuing digital certificates to be stored in the devices such as the image forming device 100 at the factory E. The communication terminal 150, the production management device 140 and the CA management device 400 are all connected to the Internet 103 in the second preferred embodiment.

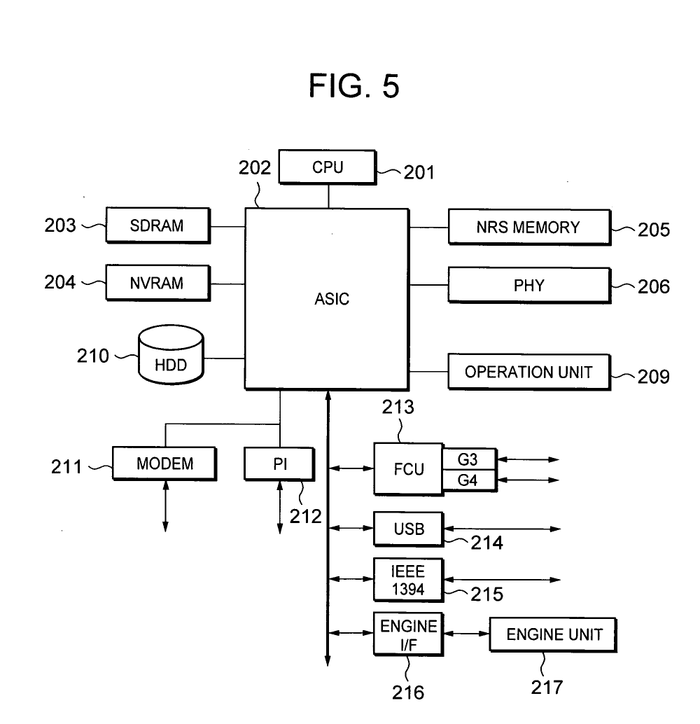

Referring to FIG. 5, a description will be given for a preferred embodiment of the image forming apparatus 100 according to the current invention. FIG. 5 is a block diagram illustrating a preferred embodiment of the physical construction of the image forming apparatus 100. The image forming apparatus 100 includes a central processing unit 201 (hereinafter also referred to as a “CPU”), an application specific integrated circuit (ASIC) 202, a SDRAM 203, a non-volatile random access memory (NVRAM) unit 204, a NRS memory unit 205, a physical media interface (PHY) 206, a NVRAM (nonvolatile RAM) 207, an operation panel 209, a hard disk drive (HDD) 210, a modem 211, a PI (personal interface) board 212, a fax control unit (FCU) 213, universal serial bus (USB) 214, EEE 1394 215, a LP reading/writing unit 216 and other peripheral apparatus 217. The CPU 201 is a calculation means to perform data processing or function controlling via the ASIC 202. The ASIC 202 is a multi-functional device board and includes a CPU interface, a SDRAM interface, a local bus interface, a PCI interface, a media access controller (MAC) and a HDD interface. The ASIC 202 provides a device common ownership and supports the effective development of the interchangeable system service and application software programs.

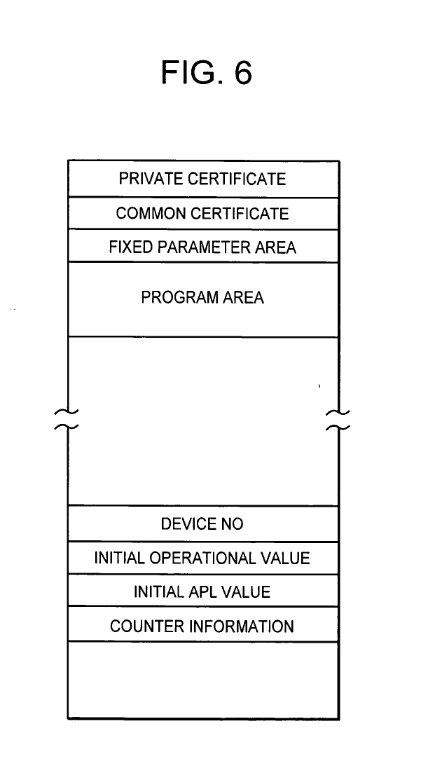

Various memory units will be described. The SDRAM 203 is a main memory unit for providing a work memory area for the CPU 201 to perform the data processing as well as a program memory area for storing the operating system (OS) and other application programs. The SDRAM 203 may be replaced by DRAM or RAM. The NVRAM 204 is non-volatile and stores the information even after power is off. The NVRAM 204 includes a program memory area for storing OS files for OS images a boot loader for activating the image forming device 100 as will be described with respect to FIG. 6. The NVRAM 204 also includes a certificate memory area for storing private digital certificates to be used for mutual confirmation by the SSL during the communication with the intermediate device 101 or the central management device 102. The NVRAM 204 further includes a common certificate memory area for storing common digital certificates that lack the device identification to be used by the SSL for mutual confirmation when the private digital certificates cannot be used. Lastly, the NVRAM 204 includes a fixed parameter memory area for storing various fixed parameters. The NVRAM 204 may be constructed by a plurality of memory units or may be distributed among the devices. The NVRAM 204 includes a device number memory area for storing device numbers for identifying the image forming apparatus 100, a memory area for storing initial operational values for the operation unit 209, initial data values for various application programs (APL) and various counter information on counter data. The NVRAM 204 may also be replaced by a non-volatile memory unit such as a non-volatile RAM back-up circuit with a RAM and batteries or EEPROM. The NRS memory unit 205 is non-volatile memory for storing NRS to be later described and adds optional NRS functions. The PHY 206 is an interface for communicating with an external device via LAN. The operation unit 209 is a operation display unit. The HDD 210 is a storage media for storing data regardless of the power status. The HDD 210 stores programs of the above described NVRAM unit 204, other programs or the data.

Still referring to FIG. 5, other components of the image forming apparatus 100 according to the current invention will be described. The modem 211 is a modulation means. When data is transmitted to the central management apparatus 102 via the public line, the data is modulated to transmit on the public line. When the modulated data is received from the central management apparatus 102, the data is demodulated. The PI 212 has an interface according to the RS485 standard and is connected to the public line via a line adapter although it is not shown in FIG. 5. The FCU 213 controls the communication via the communication line with external devices such as the central management apparatus 102 and the image forming apparatus such as digital copiers and digital multi-functional machines having a facsimile unit or a modem function. USB 214 and EEE 1394 are respectively the USB and IEEE interface standard for communicating with peripheral devices. The engine I/F 216 interfaces the engine unit 217 with the PCI bus. The engine unit 217 corresponds to a known scanner engine for image scanning or a plotter engine for image forming and a post processing unit for punching holes, stapling and sorting output paper with the formed image.

The CPU 201 activates the boot loader in the NVRAM 204 via the ASIC 202 upon the power activation. According to the boot loader, the OS images are read from the NVRAM 204 and are loaded in the SDRAM 203 to prepare a functional operating system. After completing the OS, the OS is activated. Subsequently, depending upon necessity, programs such as application programs are read from the NVRAM 204. NRS are also read from the NRS memory unit 205 into the SDRAM 203 depending upon the subsequent necessity. Various functions are implemented by the above read program data that are executed in the SDRAM 203.

Now referring to FIG. 6, a table illustrates an exemplary content of the NVRAM 204 to be used with the current application. The NVRAM 204 includes information such as a certificate and a common certificate, fixed parameters and computer programs in separate areas as shown. The NVRAM unit 204 also includes information such as a device number, an initial operational value, an initial application value, counter information and common certificate information. The above exemplary content of the NVRAM 204 is a partial illustration, and the NVRAM content is not limited to the described usage.

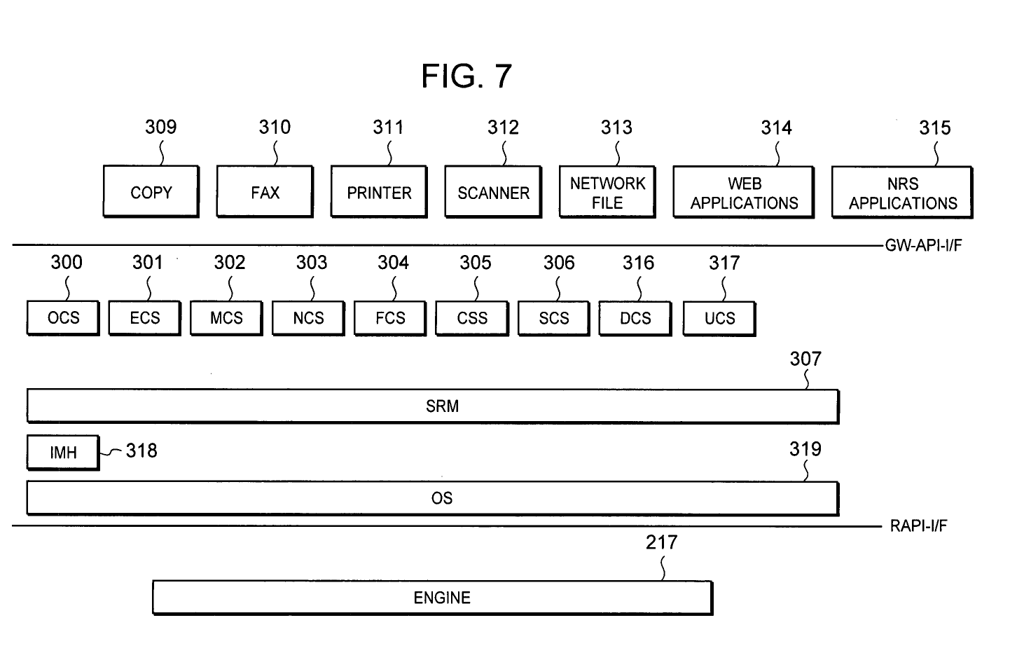

Now referring to FIG. 7, a block diagram illustrates an example of the software configuration of the image forming apparatus 100 according to the current invention. The software configuration of the image forming apparatus 100 is formed by an application module upper layer, a service module middle layer, and a versatile OS lower layer. Programs forming the software are stored in the NVRAM 204 or the NRS memory unit 205, are read out according to the needs, and executed by the CPU 201. The application module layer software includes programs to implement a plurality of predetermined application control and execution functions by operating the hardware resources via the CPU 201. The service module layer software exists between the CPU hardware and each of the application control means. The service module layer software receives operational requests for the hardware resources from a plurality of the application control means. Thus, the service module layer software includes programs to implement a service control means for controlling execution based upon the operational requests and for arbitrating the operational requests. For example, the OS 319 is an operating system such as UNIX (Registered Trademark) and processes various programs in the service module layer and the application module layer for parallel execution.

Among the above described functions, the implementation method of communicating with the central management apparatus 102 depends upon the image forming apparatus 100 and the image forming apparatus 110 with the intermediate function. That is, since the image forming apparatus 110 includes the intermediate function, the CPU executes the corresponding program to implement the communication function with the central management apparatus 102. On the other hand, in the case of the image forming apparatuses 100, it is possible to realize the functions relating to communication with the management apparatus 102 by executing the corresponding program by the controller CPU and by using the intermediate apparatuses 101.

The service module layer includes an operation control service (OCS) 300, an engine control service (ECS) 301, a memory control service (MCS) 302, a network control service (NCS) 303, a FAX control service (FCS) 304, a customer support system (CSS) 305, a system control service (SCS) 306, a system resource manager (SRM) 307, an image memory handler (IMH) 308, a delivery control service (DCS) 316, and a user control service (UCS) 317. Also, the application module layer includes a copy application 309, a FAX application 310, a printer application 311, a scanner application 312, a Net File application 313, a web application 314 and new remote service applications (NRS) 315.

A more detailed description of the above-mentioned modules and applications will be given below. The OCS 300 is a module for controlling the operation panel 209. The ECS 301 is a module for controlling the engine unit such as the hardware resources. The MCS 302 is a module for performing memory control. For example, the MCS 302 obtains and releases image memory, and uses the HDD 201. The NCS 303 is a module for performing an intermediate process between a network and each application program in the application module layer. The FCS 304 is a module for performing facsimile transmission and reception, facsimile reading, facsimile reception and printing, and the like. The NRS 305 is a module for converting data to be transmitted via the network. The CSS 305 also includes combined modules for providing the functions related to the remote management to communicate with the central management apparatus 102 via the network. The SCS 306 is a module for the activation and deactivation management of each application program in the application module layer based upon the contents of a command. The SRM 307 is a module for performing system control and resource management. The IMH 308 is a module for managing memory which temporarily stores image data.

The DCS 316 is a module for transmitting and receiving an image file or the like stored (to be stored) in the HDD 201 or the memory on the controller board 200 by using SMTP (Simple Mail Transfer Protocol) or FTP (File Transfer Protocol). The UCS 317 is a module for managing user information, such as destination information and address information that are registered by a user of the apparatus. The copy application 309 is an application program for realizing copy service. The FAX application 310 is an application program for realizing FAX service. The printer application 311 is an application program for realizing printer service. The scanner application 312 is an application program for realizing scanner service. The Net File application 313 is an application program for realizing Net File service. The web application 314 is an application program for realizing web service. The NRS application 315 includes an application program for realizing remote management functions including data conversion for the data transmission via network.

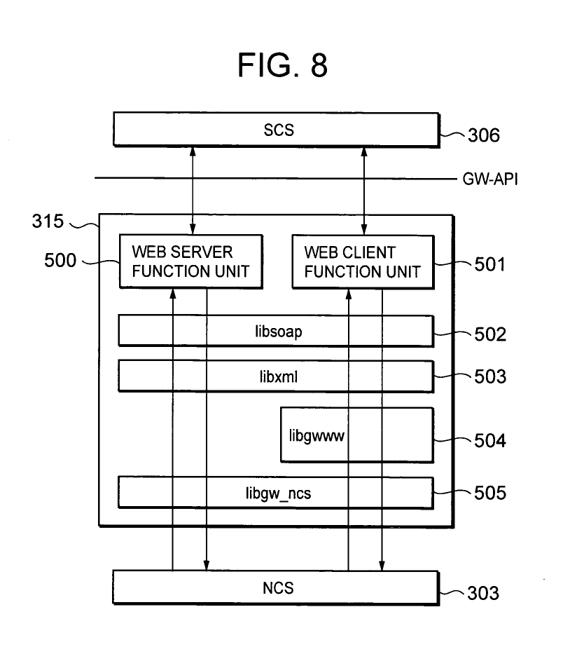

Now referring to FIG. 8, a functional block diagram illustrates one preferred embodiment of the modules of the NRS 315. As shown in FIG. 8, the NRS 315 performs processes between the SCS 306 and the NCS 303. A web server function part 500 performs a response process for a request received from the outside. The request may be, for example, a SOAP request according to the SOAP (Simple Object Access Protocol) described in a structured language such as the XML (Extensible Markup Language) format. The web client function part 501 performs a process of issuing a request to the outside. A libsoap 502 is a library that processes data in the SOAP format. A libsoap 502 is a library of software modules that process the SOAP data. A libxml 503 is a library of software modules that process data described in the XML format. In addition, a libgwww 504 is a library that processes data in the HTTP format. A libgw_ncs 505 is a library that performs processes with respect to the NCS 303.

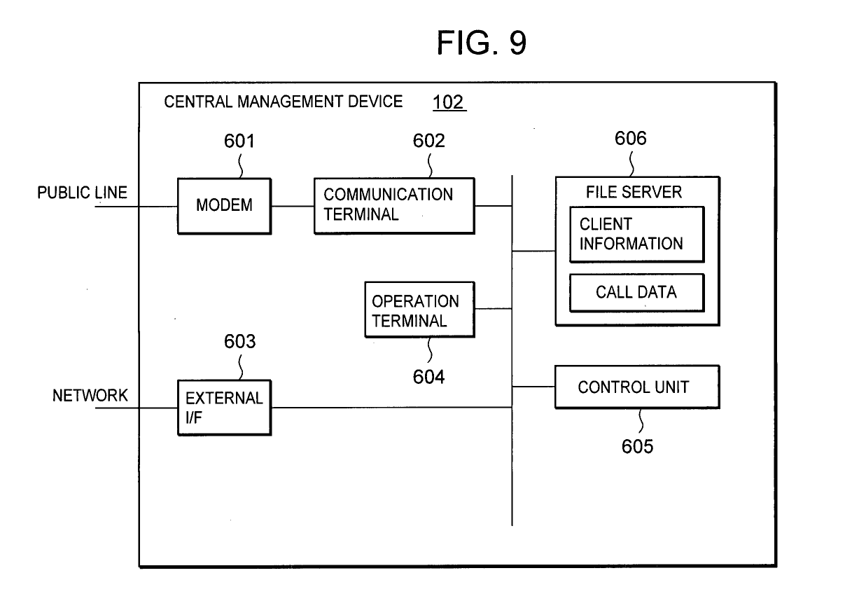

FIG. 9 is a block diagram showing an example of the components of the central management apparatus 102. The management apparatus 102 includes a modem 601, a communication terminal 602, an external communication interface (I/F) 603, an operator terminal 604, a control unit 605 and a file server 606 The modem 601 communicates with the intermediate apparatus 101 or the image forming apparatus 110. For example, the user's destination is the image forming apparatus via a public line. The modem 601 respectively modulates and demodulates transmission data and reception data. The modem 601 serves as communication means together with the communication terminal 602, which will be described later. The communication terminal 602 controls data transmission and reception at the modem 601. The external I/F 603 is a communication interface for the network such as the Internet or a dedicated line. The I/F 603 interfaces with the intermediate device 101 or the image forming device 110 at the device user side. Alternatively, a proxy server may be provided for security.

The operator terminal 604 is a terminal that the management center operator operates. The operator terminal 604 accepts inputs of various data via an input device such as a keyboard when an operation is conducted thereon by the user and displays the information to be reported to the operator. The input data includes client information such as IP addresses and telephone numbers that are used to communicate with the intermediate apparatus 101 or the image forming device 110 on the device user side. The control unit 605 further includes a microcomputer with a CPU, a ROM and a RAM and generally controls the management device 102 in an overall manner. The CPU executes the above described program as necessary and selectively utilizes the units for performing the processes. The file server 606 includes a memory device such as a hard disk drive that is not illustrated in the diagram. The memory device stores the IP addresses and the telephone numbers of the intermediate apparatus 101 and the image forming apparatus 110 of the each device user, data received from the above devices, data input from the operation terminal 604, device and customer databases to be described later and various data including the software programs according to the current invention. Among the above described image forming management systems, a mode such as the image forming device 100, 110, the intermediate device 101 or the management device 102 performs the SSL identification process upon communicating with another mode only after a successful identification process.

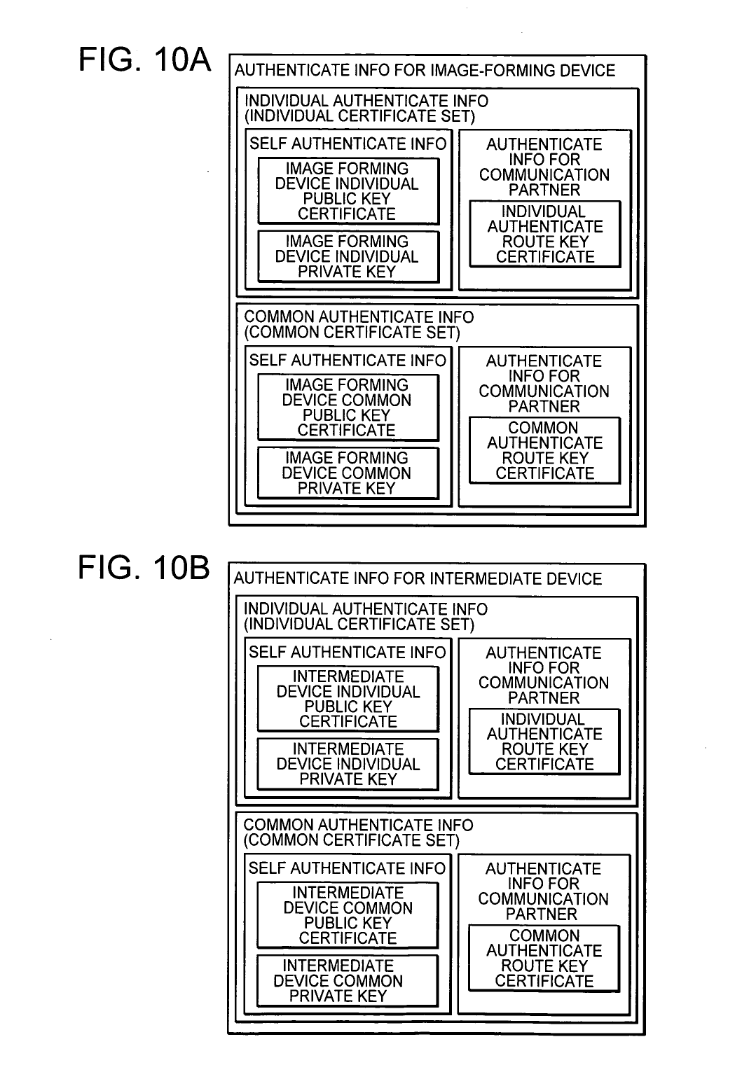

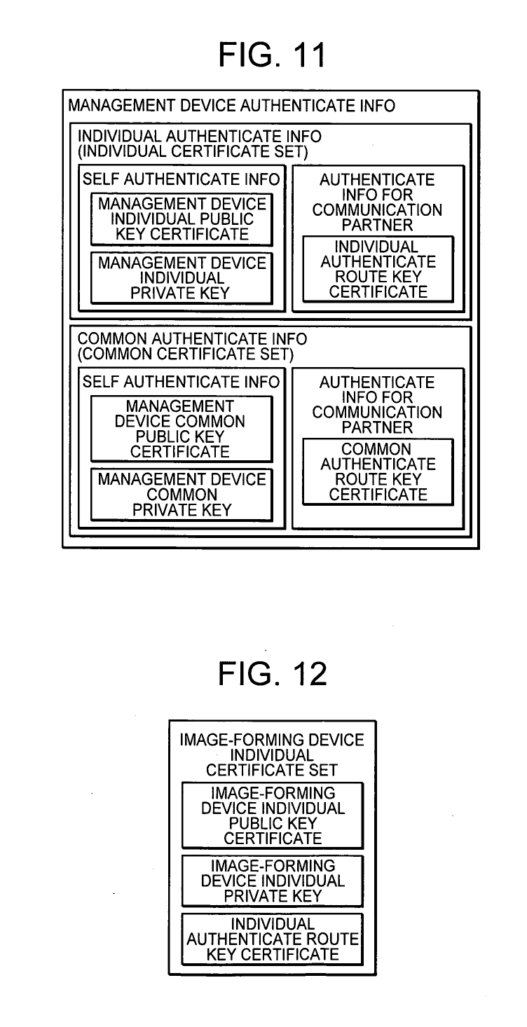

Now referring to FIG. 10A, 10B and 11, the authenticate information will be described. FIG. 10A is a block diagram illustrating the authenticate information that the image forming device 100 or 110 stores according to the current invention. FIG. 10B is a block diagram illustrating the authenticate information that the intermediate device 101 stores according to the current invention. FIG. 11 is a block diagram illustrating the authenticate information that the management device 102 stores and utilizes for the authentication process according to the current invention. In general, the authenticate information stored in the image forming device 100 or 110, the intermediate device 101 and the management device 102 includes private authenticate information and common authenticate information. The private authenticate information and common authenticate information each further include a set of the self authenticate information on an individual public key certificate and a private key as well as the communication partner authenticate information on a route key certificate.

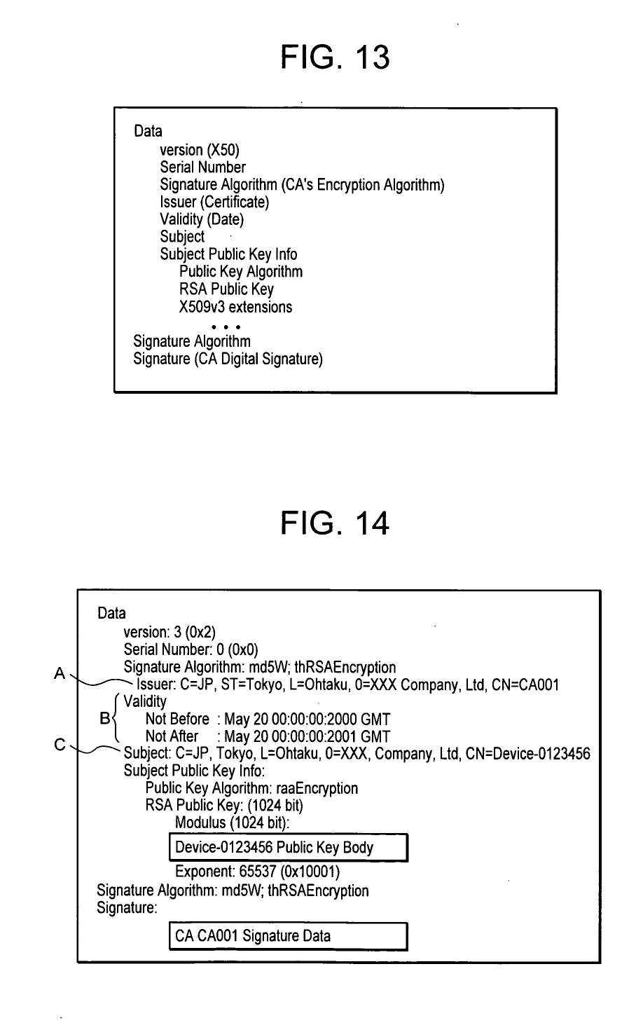

For example, as illustrated in FIG. 10A, the image forming device individual public key certificate is a digital certificate based upon an individual public key which the certificate management device 400 has issued to the image forming device 100, 110 and has been added a digital signature for authenticity according to an individual authenticate route key. One exemplary format for the public key certificate will be illustrated in FIG. 13. Similarly, the image forming device individual private key is a digital certificate with an added digital signature for self authenticity based upon a private key which corresponds to the above individual public key. Lastly, the individual authenticate route key certificate is a digital certificate with an added digital signature for self authenticity based upon a private route key which corresponds to the above individual authentic route key. When a plurality of image forming devices 100, 110 is provided, the digital signature to be added to the individual public key at each device is generated based upon the same route private key, and the route key certificate for a normal route is common among the devices. On the other hand, the individual public key and the corresponding private key in the individual public key certificate are different among the devices.

Now referring to FIG. 13, an exemplary format is illustrated for the public key certificate according to the current invention. The format includes a version, a serial number, a signature algorithm that the CA utilizes to encrypt the signature, an issuer certificate, a validity date, a subject to which the certificate is used, subject public key information, a signature algorithm and a CA digital signature. The subject includes a device or a user who utilizes the certificate. The subject public key information further includes a public key algorithm, a RSA public key and X509v3 extensions. In this example, the certificate has been generated based upon a predetermined X509 format.

Now referring to FIG. 14, an exemplary content is illustrated for the public key certificate according to the current invention. In this example, the certificate has been generated based upon a version 3 (0x2) of the predetermined X509 format. The issuer as pointed by A and the subject as pointed by C respectively indicate the identification of the certificate authority (CA) and the subject to which the certificate is used. The identification information includes the location, name, device or code. The validity as indicated by B includes a time period during which the certificate is valid.

Now referring to FIG. 10B, a block diagram illustrates the authenticate information that the intermediate device 101 stores according to the current invention. The relationships among the intermediate device individual public key certificate, the intermediate device individual private key and the individual authenticate route key certificate are substantially identical to those among the above image forming device individual public key certificate, the above image forming device individual private key and the individual authenticate route key certificate. Furthermore, the individual authenticate route key is the same regardless of the subject device in the public key certificate, and the authentication of the individual public key certificate is confirmed based upon the same individual authenticate route key regardless of the devices. For example, when the image forming device 100 and the intermediate device 101 mutually authenticate, the image forming device 100 transmits the intermediate device 101 a first random number based upon the image forming individual private key along with the image forming device individual public key certificate in response to the communication request from the intermediate device 101. At the intermediate device 101, the image forming device individual public key certificate is initially authenticated based upon the individual authenticate route key certificate to confirm its intact state. Upon the confirmation, the first random number is regenerated based upon the public key in the individual authenticate route key certificate.

After a successful regenerated random number, the intermediate device 101 identifies that the image forming device 100 as a communication partner is the issued subject as specified in the image forming device individual public key certificate and specifies a device according to the identification information in the image forming device individual public key certificate. Finally, the intermediate device 101 determines whether or not the authentication is successful based upon the specified communication partner. By the same token, at the image forming device 100, an intermediate individual public key certificate and a random number according to the intermediate device individual private key are received after the successful authentication at the intermediate device 101. The above described similar authentication is performed at the image forming device 100 based upon the received information and the stored individual authenticate route key certificate. In the above procedures, the intermediate device 101 functions as a client while the image forming device 100 functions as a server during a communication request. In the situation where the intermediate device 101 functions as a server while the image forming device 100 functions as a client, the certificate and the keys are identical between the same pair, the procedures are opposite between the intermediate device 101 and the image forming device 100.

FIG. 11 is a block diagram illustrating the authenticate information that the management device 102 stores and utilizes for the authentication process according to the current invention. The relationships among the management device individual public key certificate, the management device individual private key and the individual authenticate route key certificate are substantially identical to those among the above image forming device individual public key certificate, the above image forming device individual private key and the individual authenticate route key certificate. Furthermore, the individual authenticate route key is the same regardless of the subject device in the public key certificate, and the authentication of the individual public key certificate is confirmed based upon the same individual authenticate route key regardless of the devices. For example, when the management device 102 and the intermediate device 101 mutually authenticate, the management device 102 transmits the intermediate device 101 a first random number based upon the image forming individual private key along with the management device individual public key certificate in response to the communication request from the intermediate device 101.

At the intermediate device 101, the management device individual public key certificate is initially authenticated based upon the individual authenticate route key certificate to confirm its intact state. Upon the confirmation, the first random number is regenerated based upon the public key in the individual authenticate route key certificate. After a successful regenerated random number, the intermediate device 101 identifies that the management device 102 as a communication partner is the issued subject as specified in the management device individual public key certificate and specifies a device according to the identification information in the management device individual public key certificate.

Finally, the intermediate device 101 determines whether or not the authentication is successful based upon the specified communication partner. By the same token, at the management device 102, an intermediate individual public key certificate and a random number according to the intermediate device individual private key are received after the successful authentication at the intermediate device 101. The above described similar authentication is performed at the management device 102 based upon the received information and the stored individual authenticate route key certificate. In the above procedures, the intermediate device 101 functions as a client while the management device 102 functions as a server during a communication request. In the situation where the intermediate device 101 functions as a server while the management device 102 functions as a client, the certificate and the keys are identical between the same pair, the procedures are opposite between the intermediate device 101 and the management device 102.

As described with respect to FIGS. 13 and 14, the public key certificate has a valid time period, and it is necessary to update on a periodic basis. If the valid time period has expired after the update fails due to the power failure during the update procedure or the power remains off and no update takes place, the authentication cannot be performed based upon the invalid individual public key certificate. Since only the authentication is performed based upon the individual public key certificate at each device, a new one of an individual public key certificate, an individual private key or a route key certificate cannot be safely transmitted via network to a subject device. For dealing with the above described undesirable situations, the image forming device 100, 110, the intermediate device 101 and the management device 102 each store the common authenticate information for authenticating a communication partner using two different digital certificates. Furthermore, by using the common authenticate information, new information such as updated individual public key certificates is safely transmitted to necessary devices over the network.

Referring back to FIG. 10A, the common authenticate information includes the above described similar components for the individual authenticate information. For example, the image forming device common public key certificate is a digital certificate based upon a common public key which the certificate management device 400 or a predetermined CA has issued to the image forming device 100, 110 and has been added a digital signature for authenticity according to a common authenticate route key. The predetermined CA may or may not be the same as the certificate management device 400. The image forming device common private key is a digital certificate with an added digital signature for self authenticity based upon a private key which corresponds to the above common public key. Lastly, the individual authenticate route key certificate is a digital certificate with an added digital signature for self authenticity based upon a private route key which corresponds to the above common authentic route key. One major difference from the individual authenticate information is that the common public key certificate lacks the identification information on the subject device. For example, in the subject device as indicated by the letter C in FIG. 14, the identification information is left blank. Alternatively, the device ID in the same subject device is assigned a certain predetermined value such as “0000000” to indicate that the certificate is a common public key certificate. Furthermore, the valid period is made long so that no update is practically necessary, and the private route key for the digital signature is different from the individual public key certificate.

The above described common public key certificate is somewhat inferior in safety than the individual public key certificate containing the device identification information. However, the above described common public key certificate is used in authenticating a communication partner as a spare means in case the individual public key certificate becomes unusable. In succeeding the authentication, as described above, a safe communication link is established based upon the common key encryption after exchanging the common key with the communication partner. Consequently, a new individual public key certificate is transmitted to the communication partner through the above established communication link and is incorporated at the destination device. The certificate transmission and incorporation including the individual public key certificate is performed on a set basis, and the certificate set includes the public key certificate, the private key and the route key certificate. That is, the certificates and the keys for the authenticate process are collectively transmitted to and incorporated at the communication partner device.

Now referring to FIG. 12, a block diagram illustrates components in one example of the image forming device individual certificate set according to the current invention. The exemplary image forming device individual certificate set includes the image forming device individual public key certificate, the image forming device individual private key and the individual authenticate route key certificate. The above components are transmitted and incorporated as a set at a specified device. When the authentication process is performed based upon the common authenticate information, if it is limited to executed an update on the individual authenticate information such as the individual public key certificate, there will be no significant problem even though the safety issue is less secure due to the prolonged valid period. Furthermore, if the authenticate process is performed according to the SSL protocol, since the server does not know the client status upon the communication request from the client, it is not feasible for one device to have multiple public key certificates and to selectively transmit an appropriate one of public key certificates according to the type of the public key certificate that the communication partner uses for authentication. However, it is feasible to have a plurality of URL's for receiving communication requests and for a requesting party to request a communication request at a selective one of the URL's according to the certificate to be used at the requesting side. Thus, the individual public key certificate and the common public key certificate are selectively used according to the URL.

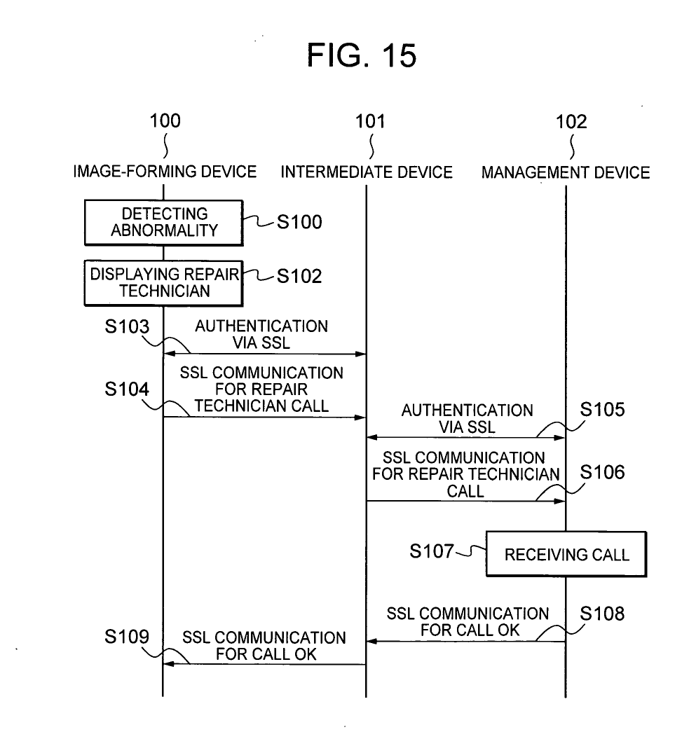

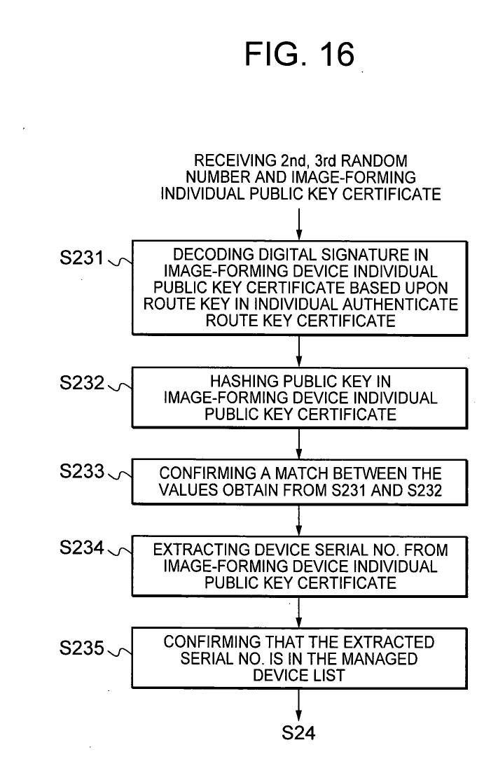

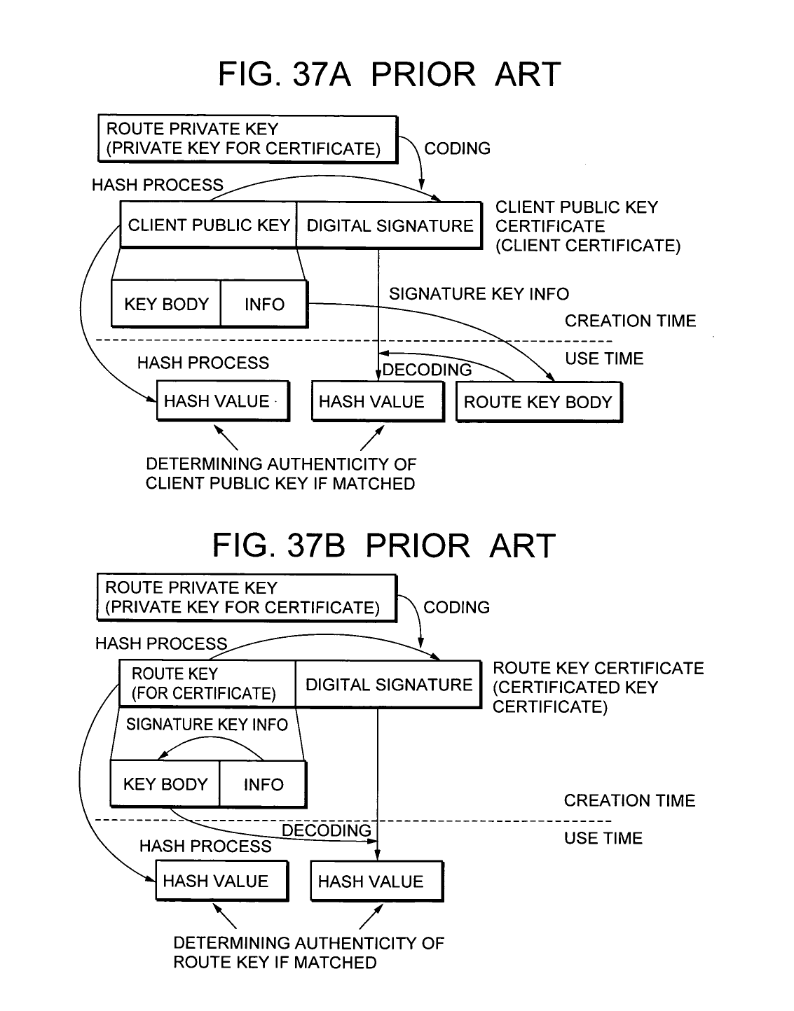

Now referring to FIG. 15, a timing diagram illustrates the operation of the image forming device management system according to the current invention. In particular, the operation is described in response to the detection of its own abnormal condition at the image forming device 100. In the image forming device management system as shown in FIG. 3, when the image forming device 100 detects its abnormal condition in a step S101, it displays at the operational unit 209 a screen in which a repair/service is called in a step S102. The image forming device 100 will transmit a repair/service call indicative of the malfunction to the management device 102 via the intermediate device 101. Prior to the repairman call transmission, the image forming device 100 and the intermediate device 101 perform the SSL mutual authenticate process in a step S103. The mutual authenticate process utilizes the individual authenticate information as described with respect to FIG. 10 and is a prior art technology as described with respect to FIG. 37 and as performed at the image forming device 100 and the intermediate device 101. However, since the public key certificate includes the device identification information, the process in the step S23 of FIG. 37 is performed as will be described in FIG. 16. After a successful authentication in the step S103, the SOAP message containing the repair/service call is transmitted in a step S104 to the intermediate device 101 via the safe communication link that has been established by the mutually authenticated SSL in the step S103.

Still referring to FIG. 15, upon receiving the repair call, the intermediate device 101 and the management device 102 also perform the SSL mutual authentication process in a step S105 as performed between the image forming device 100 and the intermediate device 101 in the step S103. Upon the successful mutual authentication in the step S105, the SOAP message containing the repair/service call is transmitted in a step S106 to the management device 102 via the safe communication link that has been established by the mutually authenticated SSL in the step S105. Upon receiving the service call in a step S107, the management device 102 returns a normal reception message back to the intermediate device 101 in a step S108. The actual dispatch of the service and or the instructions for the recovery are performed separately upon receiving the above service call, but are not illustrated in FIG. 15. The intermediate device 101 returns in a step S109 the normal service call reception to the image forming device 100 in response to the reception of the normal service call in the step S108. The above described communication is also through the SSL mutually authenticated communication links that are established either in the steps S103 and S105 or newly established in additional steps. As described above, in case of detecting an abnormal condition, the image forming device 100 reports to the management device 102. In this report, since each device accurately identifies a communication partner, the management device 102 refuses to receive a report from a device that is not included in the predetermined scope of the remote management. The management device 102 thus accurately provides the service only to the predetermined devices.

Now referring to FIG. 16, a flow chart illustrates steps involved in a preferred process of demodulating the digital signature according to the current invention. In the following steps, a server is the intermediate device 101 while a client is the image forming device 100. When the server receives the second random number, the third random number and the image forming individual public key certificate from the client, the digital signature attached to the image forming device individual public key certificate is decoded or decrypted in a step S231 based upon the route key in the individual authenticate route key certificate that is stored in the intermediate device 101. In a step S232, a hash value is obtained by hashing the public key (key body and associated information) in the image forming individual public key certificate. If the public key certificate is not damaged or altered, since the decoded value in the step S231 should match the hashed value in the step S232, it is confirmed in a step S233 that these value are the same. In a step S234, the device number information as the identification information on the image forming device 100 is extracted from the information in the image forming device individual public key certificate. It is then confirmed in a step S235 that the device number information from the step S234 is a registered device in the management device 102. Upon the above confirmation, it is then determined that an appropriate one of the image forming device individual public key certificate has been transmitted from an appropriate device. Since it is quite difficult to falsify or altered, the falsified or altered device is effectively blocked by utilizing the identification information for confirming the integrity of the public key certificate as described in the above. After the communication partner is accurately specified, it is determined whether or not the communication is appropriate. Not only the step S23 but also the step S12 in FIG. 37 are performed in the above described manner. In case of the step S12, the public key certificate to be processed is the intermediate device individual public key certificate.

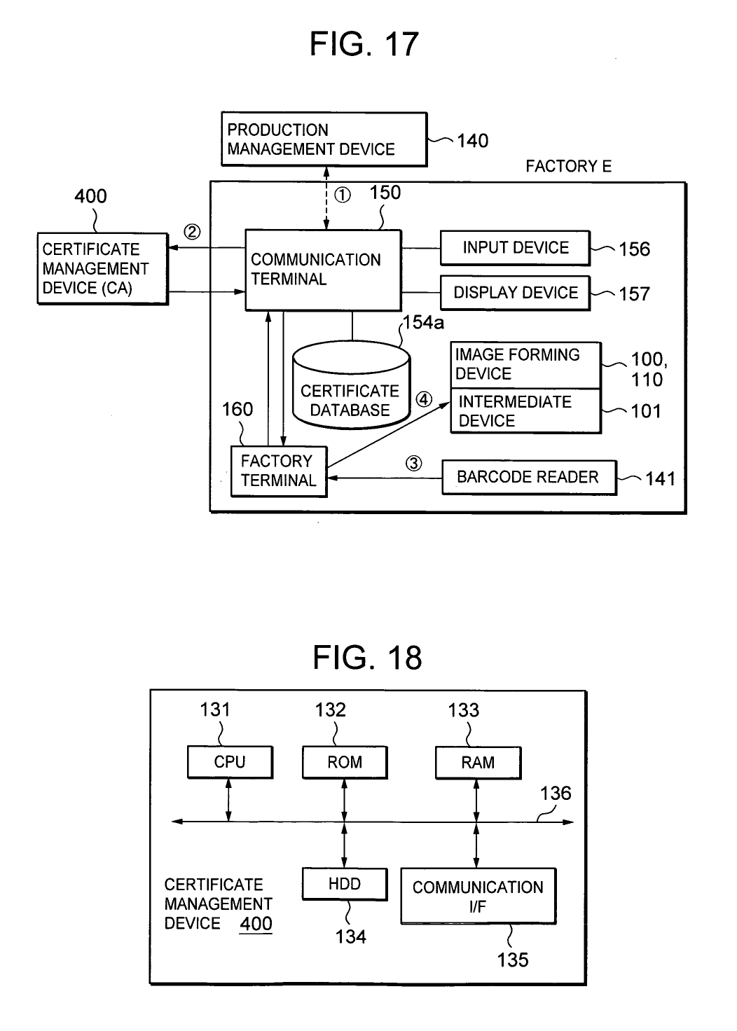

Now referring to FIG. 17, a block diagram illustrates components of the factory E in a preferred embodiment according to the current invention. Among the facility for producing the image forming devices and the intermediate devices in the above described image forming device management system, the digital certificate related facility will be further described. The factory E produces the image forming devices 100, 110 and the intermediate device 101 and includes a communication terminal 150 and a factory terminal 160. The related facility includes a certificate management device (CA) 400 and a production management device 140, which manages a production plan as well as a daily production number of communication devices such as the image forming apparatus 100/110 and the intermediate device 101. One preferred embodiment of the certificate management system includes the communication terminal 150 and the certificate management device 400 according to the current invention. One preferred embodiment of the certificate setting system according to the current invention includes the communication terminal 150 the certificate management device 400 and the factory terminal 160. Of course, the production management device 140 simultaneously plans and manages production plans for other communication devices as well as at other factories. The certificate management devices 400 issues, signs and manages the digital certificates and the private keys. The certificate management device 400 also issue and transmit the digital certificates in response to an external device.

The communication terminal 150 communicates with the outside of the production factory E to obtain necessary information or to transmit a request. The communication is performed over the Internet, the wired network or public circuits of various kinds. In the Internet environment, security is obtained by firewalls, the Secure Socket Layer (SSL) technology or the virtual private network (VPN) technologies. The communication terminal 150 corresponds to a certificate obtaining device and obtains information on a daily production number for every type of the communication devices from the production management device 140. Furthermore, the communication terminal 150 has another function to obtain information on device serial numbers including the device code and the serial number, and the obtained information is identification to be attached to the planned devices. The communication terminal 150 has a function to transmit the certificate management device 400 a certificate transmission request based upon the above obtained information. Lastly, the communication terminal 150 has a function to obtain the certificate set containing the device number from the certificate management device 400. A certificate database (DB) 154a is a database that resides in a hard disk (HD) of the communication terminal 150 and stores the certificate from the certificate management device 400. An input device 156 is an input means such as a keyboard for a terminal operator to input information into the communication terminal 150. For example, a production plan from the production management device 140 is printed and sent to the production factory E via mail or fax. The terminal operator manually enters the above information via the input device 156. A display device 157 is a display means such as a monitor. The factory terminal 160 obtains a corresponding certificate for a device from the communication terminal 150 in response to a device number that is inputted by a barcode scanned by a barcode reader 141. The factory terminal 160 transmits the certificate to the corresponding communication device and writes the certificate to a non-volatile memory of the communication device. The communication terminal 150 and the factory terminal 160 form the information processing device according to the current invention. The barcode reader 141 is a scanner for scanning the barcode information indicative of the device number or the identification information on the check sheet or the predetermined name plate on the communication device. The barcode reader 141 then transmits the scanned information to the factory terminal 160. The barcode reader 141 includes a small portable barcode reader.

Referring to FIG. 18, a block diagram illustrates components of the certificate management device 400 in the preferred embodiment according to the current invention. The certificate management device 400 further includes a CPU 131, a ROM 132, a RAM 133, a HDD 134 and a communication I/F 135, and these components are interconnected by a bus 136. The certificate management device 400 controls the operation according to the CPU by executing various control programs stored in the ROM 132 or the HDD 134 and implements the functions for a digital certificate generation means and a digital certificate transmission means.

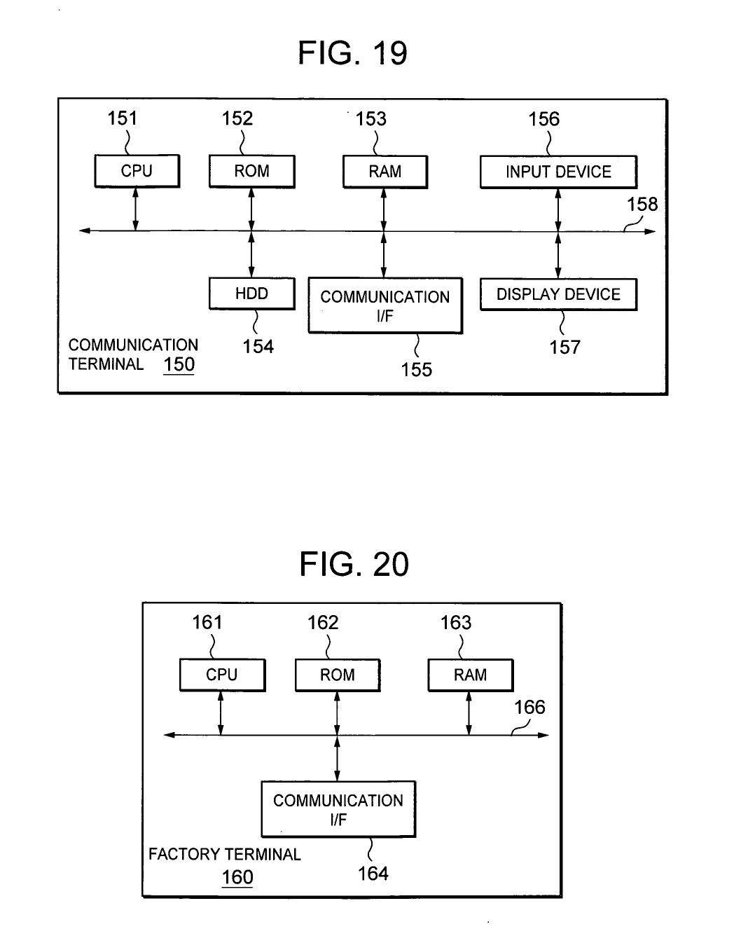

Referring to FIG. 19, a block diagram illustrates hardware components of the communication terminal 150 in the preferred embodiment according to the current invention. The communication terminal 150 includes a CPU 151, a ROM 152, a RAM 153, a HDD 154, a communication I/F 155, an input device 156 and a display device 157, and these components are interconnected by a bus 158.

Referring to FIG. 20, a block diagram illustrates hardware components of the factory terminal 160 in the preferred embodiment according to the current invention. The communication terminal 150 includes a CPU 161, a ROM 162, a RAM 163 and a HDD 164, and these components are interconnected by a bus 166.

With respect to FIGS. 12 and 13, according to the communication terminal 150 and the factory terminal 160, the CPU 151 executes the programs stored in the ROM 152 or the HDD 154 to control the communication terminal 150. Similarly, the CPU 161 executes the programs stored in the ROM 162 to control the communication terminal 160. The above described operations implement the following functions according to the current invention, including a transmission means, a storage means and, a setting means. For the hardware of the certificate management device 400, a communication terminal 150 and a factory terminal 160, a computer is used or any other hardware is added.

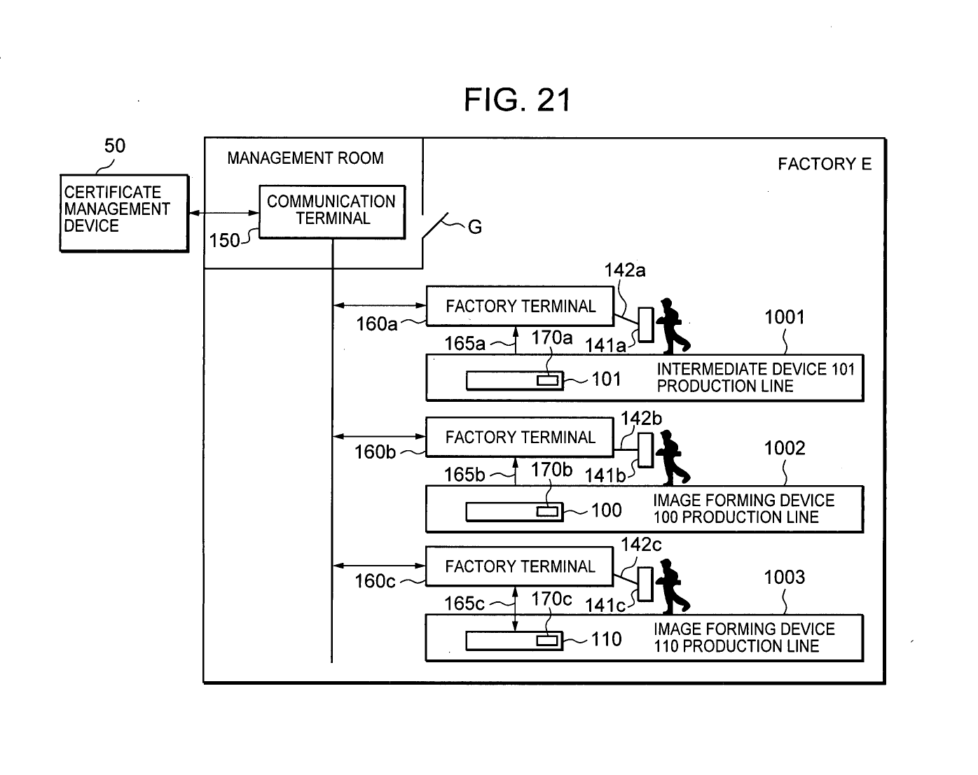

Now referring to FIG. 21, a block diagram illustrates peripheral devices around the communication terminal 150 and the factory terminal 160 at the production factory E according to the current invention. The communication terminal 150 is located in an administration room F at the production factory E for the security reasons. Only predetermined managers have access to the administration room F by a lock on the door. Furthermore, the communication terminal 150 is operational only when a predetermined ID and password are inputted. In this example, the production factory E includes a first production line 1001 for the intermediate device 101, a second production line 1002 for the image forming device 100 and a third production line 1003 for the image forming device 110. Factory terminals 160 including 106a, 160b and 160c are respectively located at the first, second and third production lines 1001, 1002 and 1003. Each of the factory terminals 106a, 160b and 160c is respectively connected to barcode I/F's 142a, 142b and 142c for the connection with barcode readers 141a, 141b and 141c. Similarly, each of the factory terminals 160a, 160b and 160c is respectively connected to a writing I/F 165a, 165b and 165c for the connection with the communication devices such as the intermediate device 101 and the image forming device 100, 110. Rated inscription plates 170a, 170b and 170c are respectively placed on the intermediate device 101, the image forming devices 100 and 110.

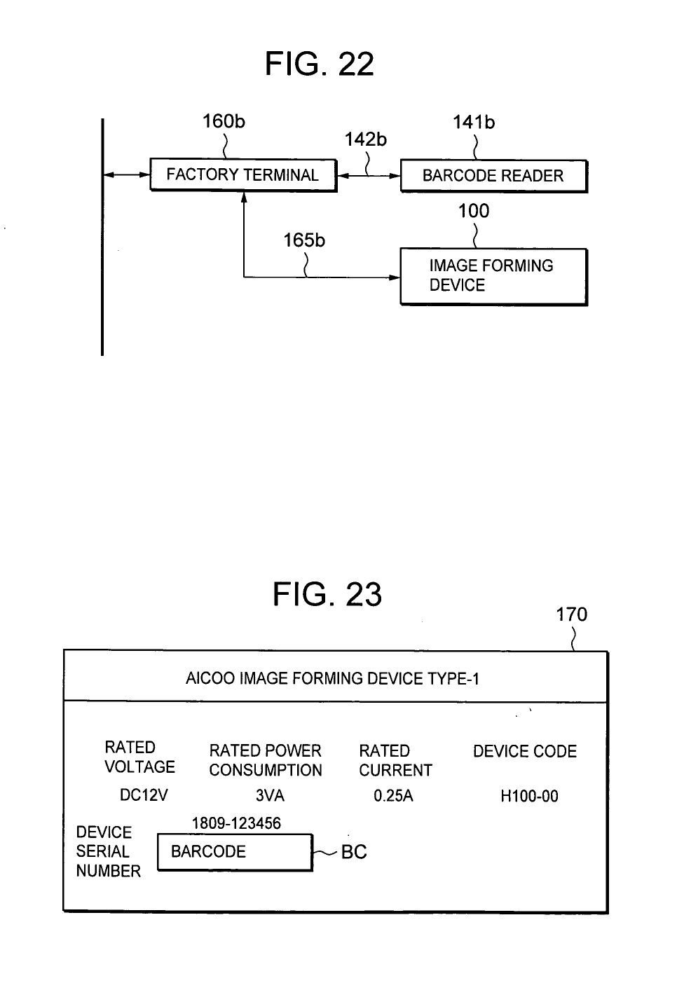

Now referring to FIG. 22, a diagram illustrates the exemplary connections among the factory terminal 160, the barcode reader 141 and the communication device according to the current invention. As described above, the factory terminal 160b is connected to the barcode reader 141b via the barcode I/F 142b. Similarly, the factory terminal 160b is connected to the image forming device 100 via the writing I/F 165. The image forming device 100, the image forming device 110 and the intermediate device 101 have the same IP address as an initial value. When the factory terminal 160 and the LAN are connected, since the IP address is duplicated, the factory terminal 160 is connected using a cross cable as the writing I/F 165.

FIG. 23 is a diagram illustrating one exemplary rated inscription plate attached to the image forming device 100 or 110 according to the current invention. After a device has been successfully tested for its functions and a serial or identification number is granted, a rated inscription plate 170 such as 170a, 170b and 170c as shown in FIG. 22 is attached to the device. The rated inscription plate also includes information on the device serial number, the rated voltage, the rated power consumption, the rated current and the device code for the image forming device TYPE-1. The barcode reader 141 scans the barcode BC information indicative of the device serial number on the rated inscription plate 170 during the individual certificate setting process as the operator places the barcode reader 141 near the plate 170. The scanned device serial number is thus inputted into the factory terminal 160. Subsequently, the factory terminal 160 obtains the certificate set containing the above inputted device serial number from the communication terminal 150 and transmits it to the connected image forming device 100 via writing I/F 165 to be placed in the corresponding individual certificate memory. By the above process or operation, the individual public key certificate containing the device serial number is easily stored. The device serial number is used as identification for the subject devices to which the certificate is tendered.

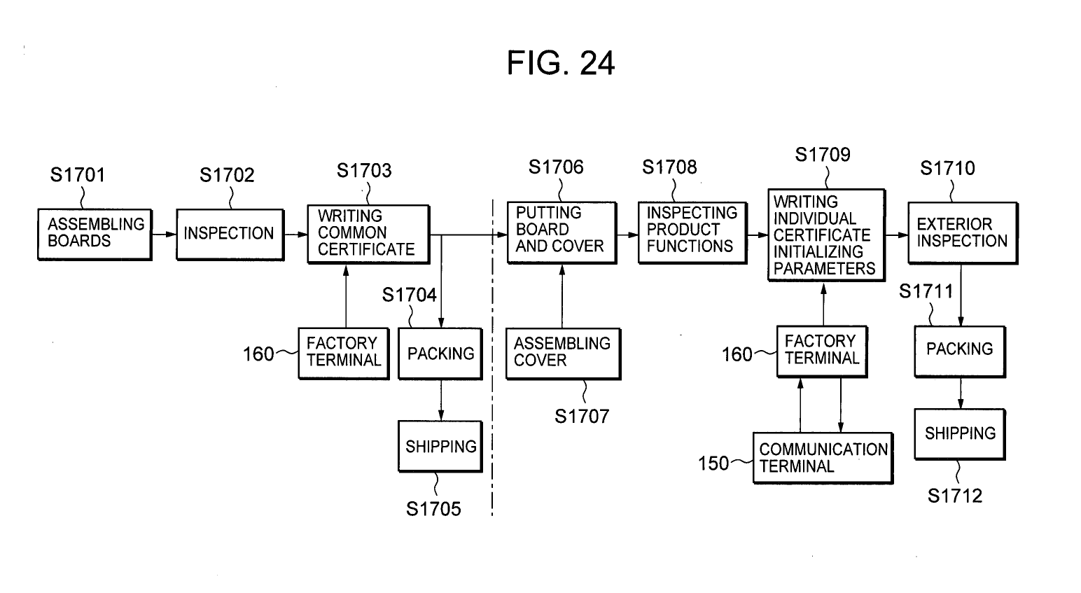

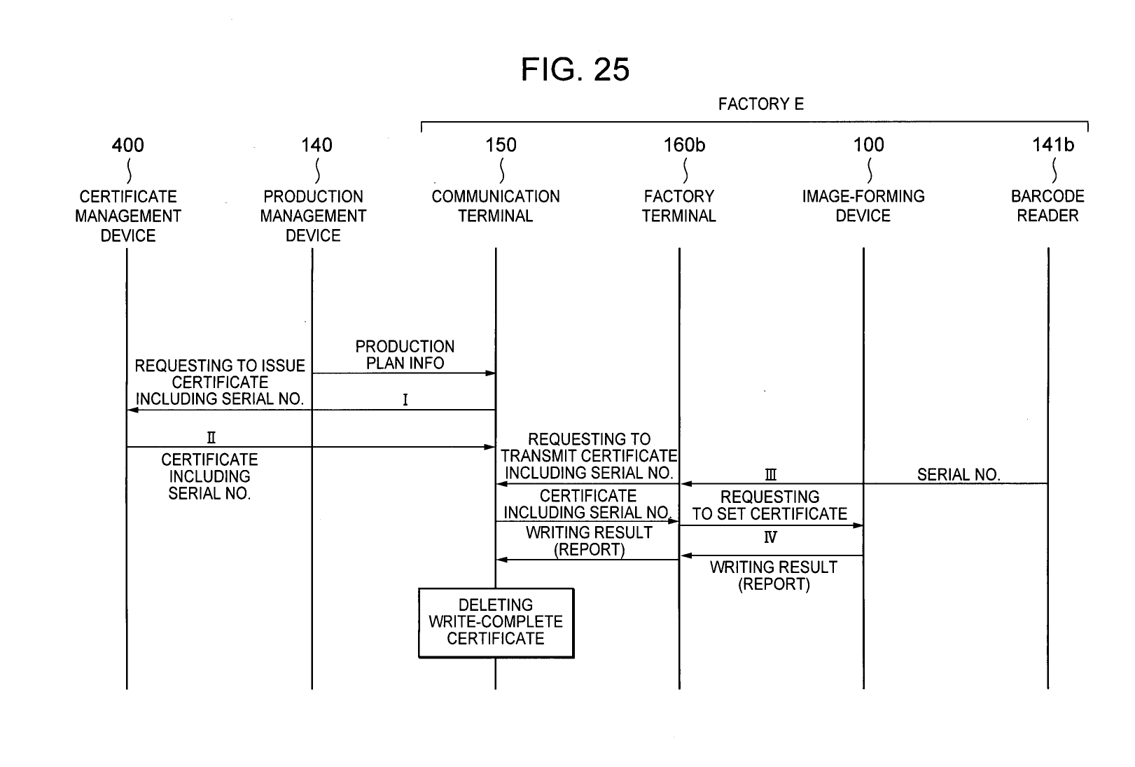

FIG. 24 is a diagram illustrating exemplary production steps of producing the communication device at the first, second and third production lines 1001, 1002 and 1003 at the production factory E of FIG. 21. At each of the first, second and third production lines 1001, 1002 and 1003, the control board is first assembled in a step S1701 for the communication devices such as the intermediate device 101 and the image forming device 100/110. Subsequently, after the control boards are inspected in a step S1702, a fixed value is written by the factory terminal 160 to the flash memory 204 or the NVRAM 207 as a common certificate as shown in FIG. 10 in a step S1703. The control boards with the common certificate written in the flash memory 204 or the NVRAM 207 are packed in a step S1704 and shipped as service parts in a step S1705. Alternatively, the control boards with the common certificate written in the flash memory 204 or the NVRAM 207 are sent to a next step S1706 to produce communication devices. The covers are assembled in advance in a step S1707 for the image forming device 100 or 110. In the step S1706, the control boards are placed on the covers to be installed in the image forming device 100 or 110 for the finished product. The inspection is performed for the functions of the product image forming device 100 and 110 in a step S1708. After the inspection, in a step S1709, the communication terminal 150 and the factory terminal 160 write the individual certificate with a device serial number in the flash memory 204, and the parameters such as a counter value to be later changed in the flash memory 204 are initialized. The above individual certificate set is the individual public key certificate that includes the device serial number information as identification to the subject devices. The exterior of the product image forming device 100 and 110 is inspected in a step S1710. Lastly, the product image forming device 100 and 110 is packaged and shipped respectively in steps S1711 and S1712. The steps S1706 through S1712 of the product assembly often take place at a factory that is different from the initial board assembling factory.

FIGS. 25 through 31 will be described with respect to steps or processes in a preferred process of obtaining and installing individual certificates according to the current invention. Although the preferred process will be described in relation to manufacturing the image forming device 100, the same process is applicable to the manufacturer of other devices. In particular, FIG. 25 illustrates an exemplary pseudo timing chart or sequence at the related devices for generating individual certificates for the image forming device management system. At the factory E, the communication terminal 150, the factory terminal 160, the image forming device 100 and the barcode reader 141 are located. The CPU 151 of the communication terminal 150 obtains a number of daily production units for each of the communication device such as the image forming device 100 from the production management system 140 at a predetermined timing each month as indicated at I. At a predetermined time, the communication terminal 150 daily generates a certificate issuance request for requesting the transmission of the individual certificate set to be installed in the communication device that is produced on that day based upon the certificate management device list database and the production plan database. The communication terminal 150 then transmits the generated certificate issuance request to the certificate management device 400. Concretely speaking, the certificate issuance request is transmitted for requesting the certificate with the device identification for the communication devices in which the individual certificate is to be installed. In response to the request, the certificate management device 400 generates the individual certificate set containing the individual public key certificate with the device serial number that has been received, and the certificate management device 400 transmits it to the communication terminal 150. The communication terminal 150 stores the retrieved certificates in the certificate database 154a as indicated by II. If the device serial number information is plural, the certificate management device 400 generates the individual certificate set in the individual public key certificate for respectively received device serial numbers and transmits it. In the above described process, the CPU 151 of the communication terminal 150 and the communication I/F 155 function as an issue request transmission means (transmission means) or a reception means. The CPU 131 of the certificate management device 400 and the communication I/F 135 function as a certificate transmission means. Furthermore, the communication terminal 150 generates the device serial number information or receives the device serial number information that has been generated by the production management device 140. From the production management point of view, the latter is preferred. It is acceptable to attach the planned production number of the device serial numbers in response to a single certificate issue request. It is also acceptable to transmit the certificate issue request for a single device serial number or a predetermined number of the device serial numbers.

After the image forming device 100 is assembled at the production line and is inspected, a device serial number is given and the inscription plate is attached. During the individual certificate installation, the operator reads the barcode BC via the barcode reader 141b after connecting the factory terminal 160b via the writing I/F 165b so that the device serial number of the image forming device 100 is inputted into the factory terminal 160b as indicated by III. The factory terminal 160b sequentially transmits to the communication terminal 150 a transmission request for a certificate that includes the device serial number. The communication terminal 150 reads a corresponding certificate from the certificate DB of the HDD 154 and transmits the certificate to the factory terminal 160 upon receiving the certificate transmission request with a device number as indicated by a barcode from the factory terminal 160. After the transmission request with the device numbers to the communication terminal 150 and upon receiving the certificates, the factory terminal 160 further transmits via the write I/F 165 the certificate set and the certificate installation request to corresponding ones of the communication devices in the image forming devices 100 whose device number has been scanned as indicated by IV. Upon receiving the certificate from the factory terminal 160, the communication device 100 transmits a reception response back to the factory terminal 160 in a step S8 after writing the certificate set in an internal non-volatile memory such as the NVRAM 204 of the image forming apparatus 100.

In the above described process, the CPU 161 of the factory terminal 160 and the communication I/F 164 function as an installation means. In communicating between the factory terminal 160 and the image forming device 100, the common certificate set that has been already stored in the image forming device 100 is utilized, and the authentication is performed by SSL. The mutual authentication is also enabled if an appropriate certificate set is stored in the factory terminal 160b. By the above authentication process, it is prevented that the image forming device 100 installs the certificate set from an erroneous factory terminal or that the factory terminal 160b transmits the certificate set to an irrelevant device. It is also prevented that a private key is not extracted from memory dump by installing the certificate set in an encrypted state based upon a predetermined encryption method. Security is further improved by utilizing SSL for the communication between the barcode reader 141 and the factory terminal 160 or between the factory terminal 160 and the communication terminal 150.

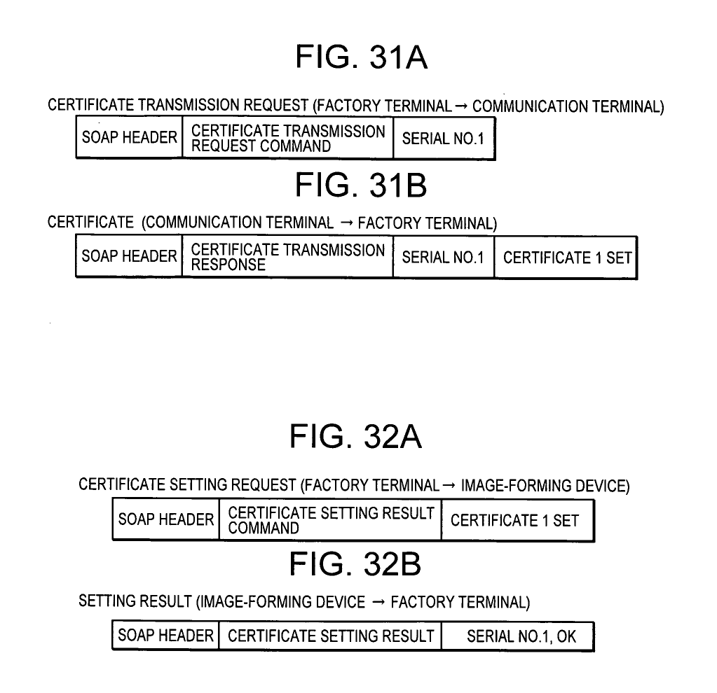

Now referring to FIG. 31, a diagram illustrates an exemplary data format for the communication between the communication terminal 150 and the factory terminal 160 for the above described process according to the current invention. In general, the communication is based upon the SOAP message for transmission and reception. The certificate transmission request corresponds to a SOAP request as shown in FIG. 31A while the corresponding certificate is a SOAP response as shown in FIG. 31B.

Now referring to FIG. 32, a diagram illustrates an exemplary data format for the communication between the image forming device 100 and the factory terminal 160 for the above described process according to the current invention. In general, the communication is based upon the SOAP message for transmission and reception. The certificate installation request corresponds to a SOAP request as shown in FIG. 32A while the corresponding installation result is a SOAP response as shown in FIG. 32B.

Upon receiving the reception response from the image forming device 100 for the certificate installation request, the factory terminal 160 in turn transmits the received reception response to the communication terminal 150. If the above write is confirmed successful, the certificate writing completion flag is set to ON in the certificate DB to prevent the duplicate use of the certificate set. Since the above flag clearly indicates the devices with the installed certificate set, productivity improves. In case of the failed installation, the certificate issue request is sent to the certificate management device 400. Subsequently, the certificate set containing the same device serial number for the failed installation is obtained, and the above described process is repeated for installing in the certificate the communication terminal 150.

For the security of the certificates, the certificates are maintained only for a certain amount of time. If the same certificate is stored in the certificate DB 154a for a long period of time, after the write completion result is received from the factory terminal 160, the certificate management device 400 deletes the corresponding certificate from the certificate DB 154a. Upon receiving the reception response from the factory terminal 160, the corresponding certificate may be deleted from the certificate DB 154a.

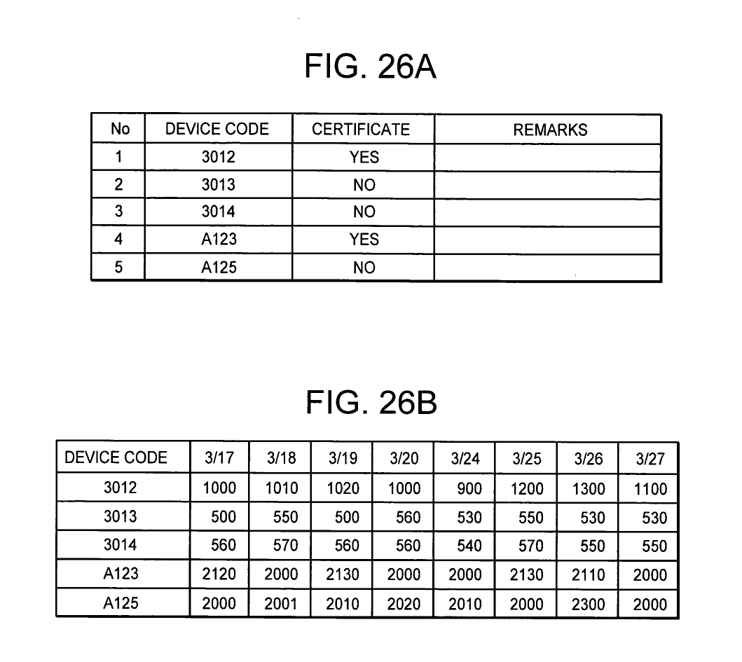

Now referring to FIGS. 26A and 26B, tables illustrate exemplary contents of the factory production management database that is obtained from the production management device 140 and is stored in the HDD 154 of the communication terminal 150 according to the current invention. FIG. 26A is a table illustrating the database content for the certificate management device list. The certificate management device list database includes a list of device codes of the devices that are produced at the factory E. For each device, the list indicates whether or not a corresponding certificate exists. For example, for the device code number 3012, the corresponding certificate exists while for the device code number 3013, the corresponding certificate does not exist in the database. The individual certificate installation is not necessary for devices that are not remotely managed as indicated in the above database. For those remotely managed devices, the above described process is performed to obtain and install the individual certificate set. FIG. 26B is a table illustrating the database content for the daily production plan for each device type at the factory E. For each of the specified dates, a number of production units is specified for each of the devices that are identified by the device code. For example, on March 19, five hundred sixty units are to be produced for the device 3014.

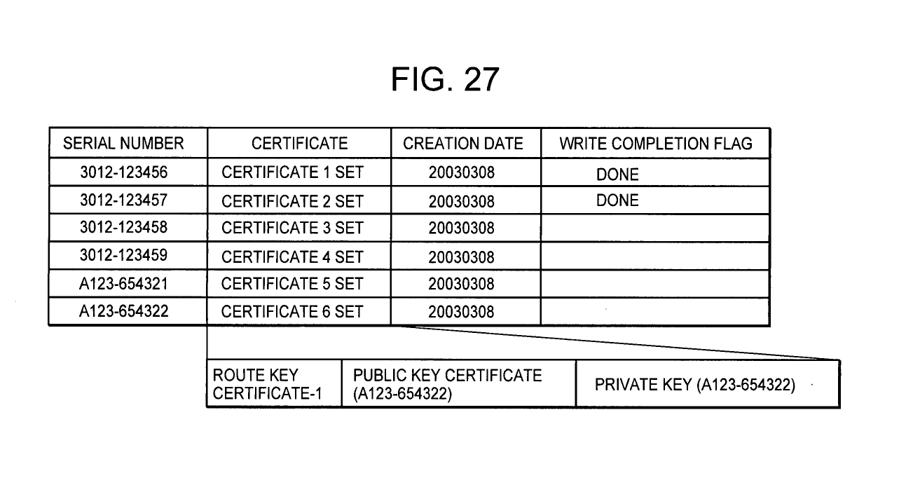

FIG. 27 is a table illustrating exemplary contents of the certificate database 154a in the HDD 154 of the communication terminal 150 according to the current invention. The certificate database 154a includes information on device serial numbers, digital certificates, creation dates and write completion flags. Each of the digital certificates further includes a route key certificate or a public key certificate and a private key in a single set. For example, the certificate 1 set that is created on Mar. 8, 2003 has been written on the device number 3012-123456 as indicated by the write completion flag.

On the other hand, the certificate 3 set that is created on Mar. 8, 2003 has not yet been written on the device number 3012-123458 as indicated by the write completion flag. To illustrate the content of the certificate set, the certificate 6 set further includes the route certificate-1, the public key certificate (A123-654322) and the private key (A123-654322).

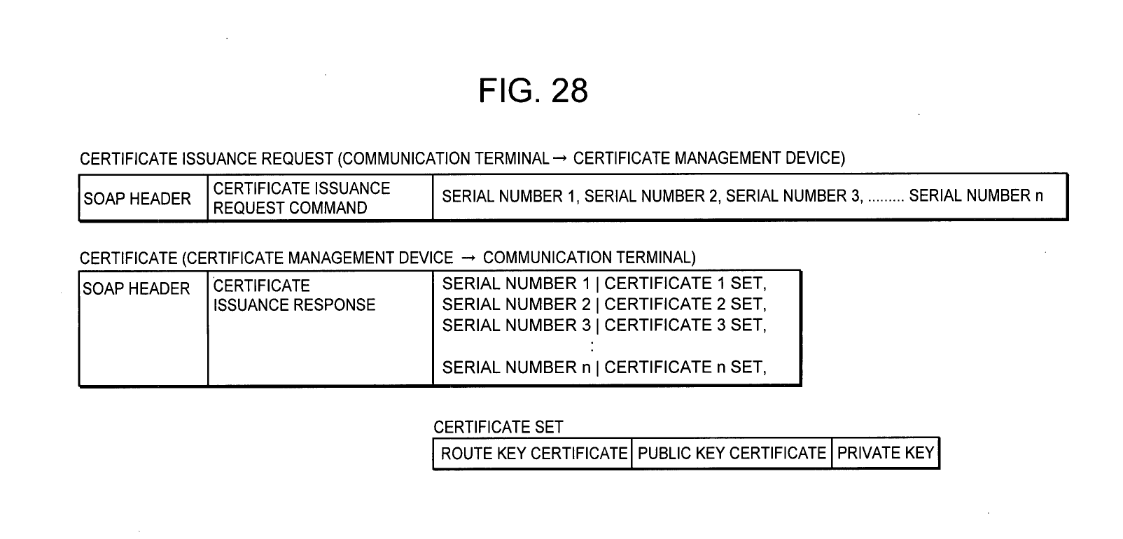

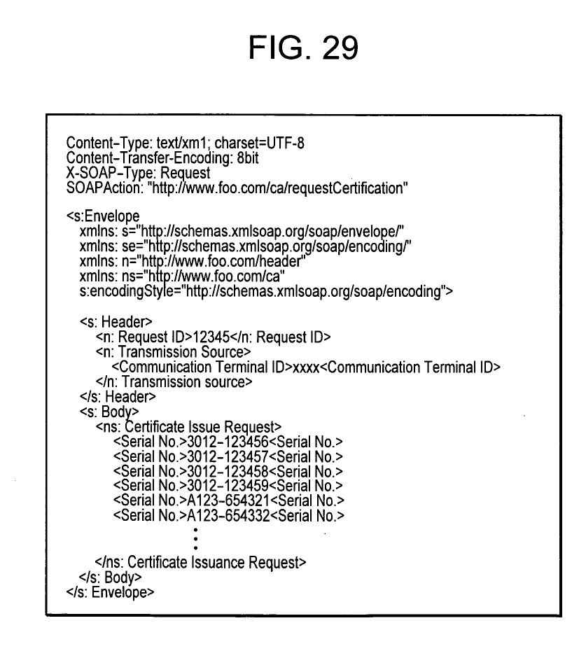

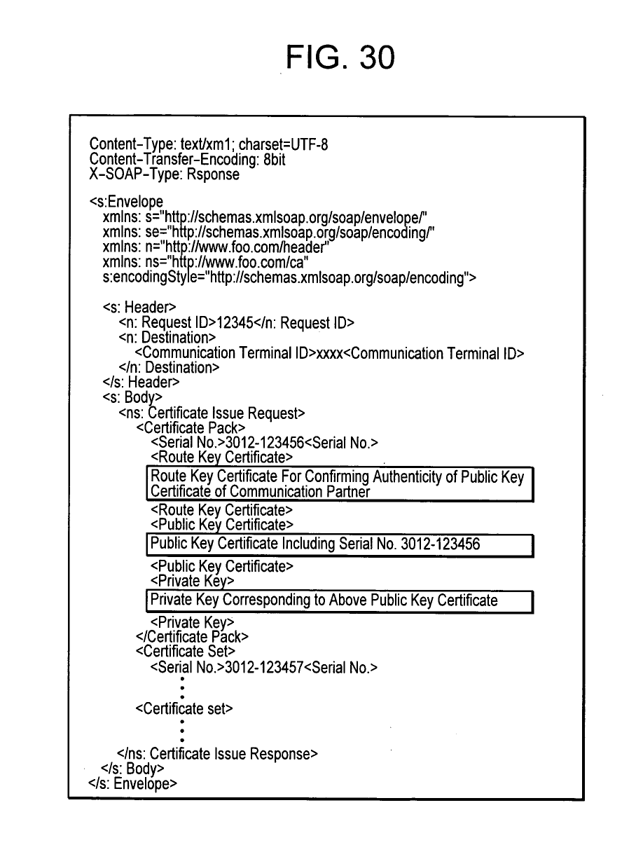

FIG. 28 illustrates exemplary contents in the SOAP format to be used for communicating from the communication terminal 150 to the certificate management device 400 according to the current invention. For example, a certificate transmission request further includes a SOAP header, a certificate issuance request command as well as the data indicating the device serial number 1 through n. Another example is a certificate transmission which further includes a SOAP header, a certificate issuance response as well as the data indicating the device serial numbers 1 through n with the corresponding certificate sets 1 through n. The above messages are indicated in the XML language as will be illustrated in FIGS. 29 and 30.

FIG. 29 illustrates exemplary contents in the SOAP request to be used for communicating according to the current invention. For example, a SOAP body includes the certificate issue request tag. Under the tag, a plurality of the serial number information is provided on the devices in which the certificate set is to be installed.

FIGS. 30A and 30B illustrate exemplary contents in the SOAP response for communicating between the communication device such as the image forming apparatus 100 and the factory terminal 160 according to the current invention. The SOAP body of the SOAP response includes a certificate issue request response tag to indicate a response to the certificate issue request. Under the tag, the certificate set containing the route key certificate, the public key certificate and the public key is issued for each of the devices whose serial number is provided in the certificate issue request. By the above, the communication terminal 150 obtains a necessary number of the certificate sets containing the device serial number information for identification from the certificate management device 400 according to the production plan obtained from the production management device 140. The certificate set is installed in the manufactured communication devices such as in the image forming device 100, 110 or the intermediate device 101 via the factory terminal 160.

In the above described system and process, the following effects are obtained. The communication terminal 150 transmits to the certificate management device 400 the certificate issue request and the identification information on the communication device in which the certificate set is to be installed. In repose to the request, the certificate management device 400 transmits the certificate set containing the public key certificate for the transmitted identification information. The communication device subsequently receives the above certificate set. The above allows that the public key certificate containing the identification information is installed in the individual communication device. Even though the unique certificate set is stored in every device, the certificate set is obtained in a facilitated manner. The above certificate set is installed in the communication device that has the same identification information as in the public key certificate in the certificate set. Thus, even though the unique public key certificate containing the identification information on the communication device, the certificate set is obtained in a facilitated manner. After installing the public key certificate containing the unique identification information, the identification information is used during the SSL authentication. It is practically impossible to alter the identification information contained in the public key certificate since the altered identification information is detected upon the reference to the digital signature. By obtaining and installing the above certificate set containing the identification information, the communication device is easily provided to protect the false pretense by a dishonest user. For the above reasons, it is substantially difficult to pretend to be another device. Furthermore, by availing the identification information from the production management device 140 to the certificate management device 400, the communication terminal 150 singularly and efficiently manages the identification information of the communication devices to be manufactured at various production factories at the production management device 140.

Alternatively, the manufactured communication device and the corresponding identification information are distributed in pair so that the identification information is scanned by the scanner into the factory terminal 160. In response to the identification input, the factory terminal 160 obtains the digital certificate containing the same identification from the communication terminal 150 and installs the digital certificate in the corresponding paired communication device. This allows the accurate installation of the certificate containing the identification which matches that of the communication device. In the above preferred embodiment, although the operator scans the barcode on the inscription plate 170 using the portable barcode reader 141, the information is alternatively scanned by a fixed barcode reader or an image of the information is captured for recognizing the numbers and the characters. In stead of the inscription plate, a check sheet is used for containing the information. Lastly, the identification information is alternatively inputted by hand via the input device 156 of the communication terminal 150. It is further suggested that the communication terminal 150 obtains and stores only the certificate sets for the communication devices to be manufactured within a predetermined period, in the unlikely event that the certificate sets are stolen or leaked from the communication terminal 150, security is improved since no future units are affected by the compromise. On the other hand, if the number of the temporarily stored certificate sets is small, when a communication problem occurs between the communication terminal 150 and the certificate management device 400, the production is undesirably affected. For the above reason, the size of the certificate sets should be for a substantial period of time such as a whole day, several days or a whole week. If it is important to maintain the production in the event of the communication failure, one month period of the certificate sets is obtained and stored at a time, and the production plan database is updated not only once a month.

In the event of terminating the production of a certain device type, it is processed in a planned manner not to leave the certificate sets in the certificate DB 154 at the communication terminal 150. If the certificate sets are left at the communication terminal 150 after the termination, the administrator removes the remaining certificate sets from the certificate DB 154 via the input device 156 of the communication terminal 150. The CPU 151 of the communication terminal 150 displays at the display device 157 currently available number of the certificate sets for each device type and the number of certificates that has been used during the day.

In the event, the communication terminal 150 receives the certificate transmission request from the factory terminal 160 without the certificate DB 154a. The communication terminal 150 transmits the certificate reception request and the received device serial number information to the certificate management device 400. Upon receiving the certificate set, the communication terminal 150 returns the certificate set to the factory terminal 160. If the certificate management device 400 processes at a sufficiently fast rate, the above described embodiment is acceptable and reduces the overall costs due to the lack of the certificate DB. In the above description of the preferred embodiments, the example of the public key certificate as a certificate set has been described. The public key certificate and the public key do not need to be simultaneously installed for the route key certificate.

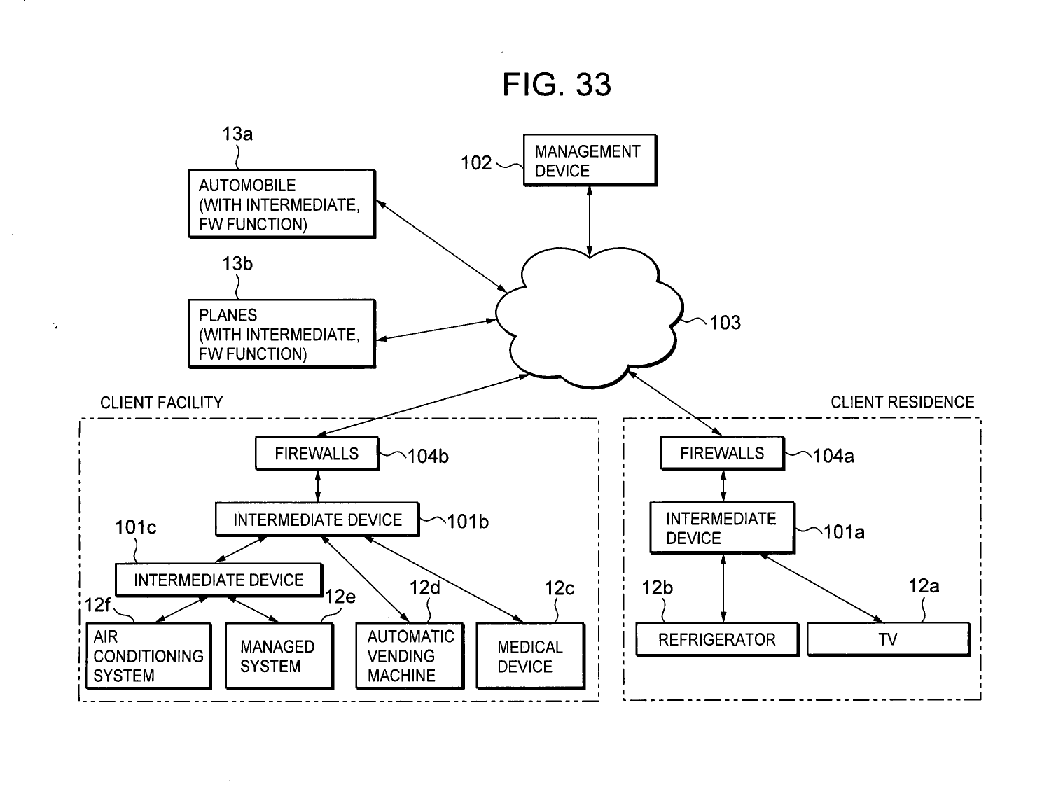

Also, the above described preferred embodiments are appropriate for the communication terminal 150 and the factory terminal 160 for writing the certificates in the non-volatile memory of the image-forming device 100, 110 and the intermediate device 101. The current invention is not limited to the above described preferred embodiments but also applicable to the apparatuses or systems for writing the certificate in the non-volatile memory of the communication devices such as computers that are connectable to the network, communication units equipped in the automobile and the airplane, a measuring system for utility such as air conditioning, gas, water and electricity, power supply units, medical devices, automatic vending machines and networked appliances. For example, FIG. 33 illustrates a remote management system includes the above described devices and units as managed devices based upon the remote system as shown in FIG. 1. The exemplary managed devices without the intermediate device function include a television set 12a, networked home appliance such as a refrigerator 12b, a medical device 12c, a vending machine 12d, a meter system 12e and an air conditioning system 12f. The exemplary managed devices with the intermediate device function include an automobile 13a and an air plane 13b. It is also preferred to include the firewall functions in the automobile 13a and the air plane 13b, which travel over a wide area. In the above remote management system, the current invention is applicable to write the certificate in the non-volatile memory of the devices or units as the managed devices. The devices such as the certificate management device 400, the production management device 140, the communication terminal 150 and the factory terminal 160 are each not limited to a single device but also multiple devices in the same remote management system. Contrarily, the above devices are made into a single device having the multiple functions in the remote management system. Lastly, the location of the above devices is not limited to the disclosed location.

The software programs according to the current invention realize the various functions including the transmission means, the reception means, the installation means and others at the computer controlling the communication terminal 150 and the factory terminal 160. By executing the software programs by the computers, the above described effects are obtained according to the current invention. The software programs have been initially stored in the storage means such ROM or HDD of the computer. Alternatively, the software programs are stored in the non-volatile storage media such as a memory card, EEPROM, SRAM or storage media such as CDROM or floppy disks. The software programs are loaded or installed in the computer memory for execution to perform the above operations. The software programs are alternatively downloaded via network from an external storage device.

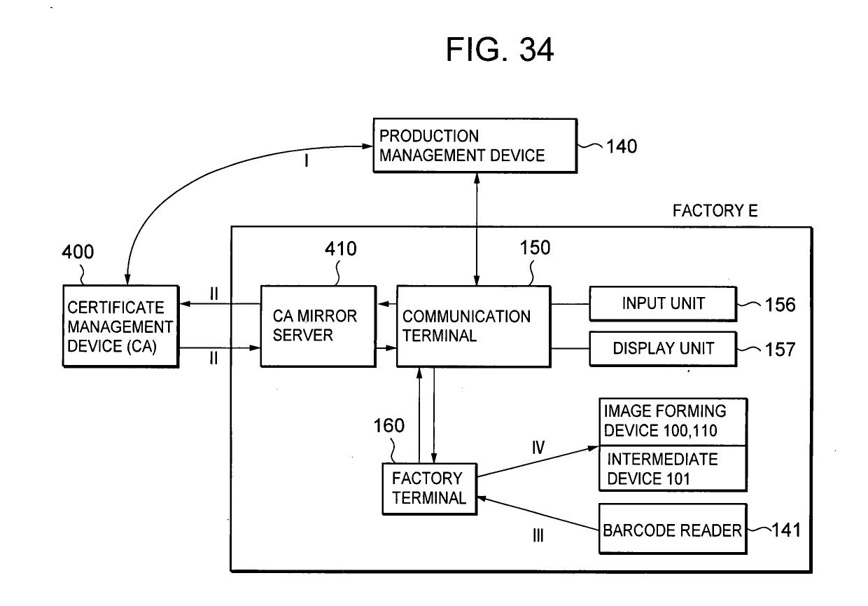

In the alternative embodiments, the components are substantially identical to those in the above preferred embodiments. Similarly, the steps involved in the associated processes are also substantially identical those of the above preferred processes. One major difference is that the factory E now includes a mirror server for mirror the certificate management device. Now referring to FIG. 34, a block diagram illustrates one alternative embodiment of the communication device production factory and the related facility for installing the digital certificates according to the current invention. In the factory E, the certificate (CA) management device 400 is mirrored by a CA mirror server 410, which directly transmits the device serial numbers of the devices to be produced from the production management device 140 to the certificate management device 400 in order to issue the certificate sets including the public key certificates with the above device serial numbers. Since the certificates from the certificates management device 400 are automatically transferred to the mirror server 410, the communication terminal 150 obtains the necessary set of the certificates from the mirror CA server 410. Thus, it is not necessary to provide a certificate DB for storing the certificates from the certificate management device 400, and no such database is provided in the alternative embodiment.

Still referring to FIG. 34, the communication between the certificate management device 400 and the CA mirror server 410 is performed based upon the SSL method. The CA mirror server 410 does not necessarily mirror all of the data from the certificate management device 400. It is sufficient to mirror only data areas that store the certificate sets to be used at the factory E. Either one way mirroring or two way mirroring is acceptable. The production management device 140 communicates with the communication terminal 150 for transmitting the planned production for each device type and the corresponding device serial numbers in order to instruct the production at the factory E and the attachment of the serial numbers respectively on the manufactured devices. By the above described operations, a mismatch is prevented between the device serial numbers in the certificate sets transmitted to the CA mirror server 410 and those that are attached to the communication devices produced at the factory E.

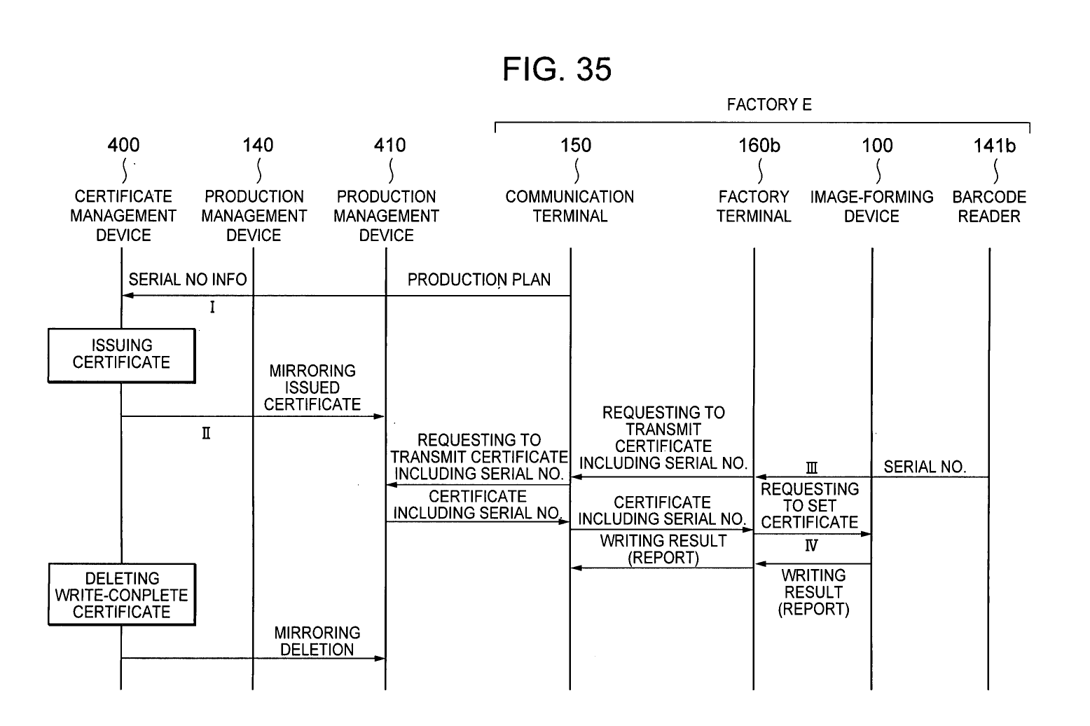

The operation will be described for installing the individual certificate with respect to the alternative embodiment of according to the current invention. FIG. 35 also indicates a flow or steps involved in the related process of installing the individual certificates by the relevant devices, and the sequence as shown in FIG. 34 for the alternative embodiment corresponds to that as shown in FIG. 25 for the preferred embodiment. The Roman numerals generally correspond each other in FIGS. 25 and 34. In the alternative embodiment, the production management device 140 generates at a predetermined time the device serial numbers for attaching to the devices to be produced on the day based upon the certificate management device list DB and the production management DB and transmits them to the certificate management device 400 as indicated as indicated by an arrow I. In the above transmission, it is not necessary to list all of the generated device serial numbers, but it is optionally sufficient to list the beginning device serial number and the number of devices. Upon receiving the information, the certificate management device 400 issues and stores the certificate set containing the public key certificate with the device serial number for each of the devices whose serial number has been received. The generated certificate sets are now transmitted to the CA mirror server 410 as indicated by an arrow II. Meanwhile, the production management device 140 also transmits the communication terminal 150 the device serial numbers to be placed on the communication devices that are produced on the day as a part of the production plan information. Subsequently, the device serial numbers are added to the produced image forming or intermediate devices. During the individual certificate installation, as indicated by an arrow III, the operator reads the barcode BC on the inscription plate 170 via the barcode reader 141b for inputting the device serial number of the image forming device 100 into the factory terminal 160b as described with respect to the above preferred embodiment. The factory terminal 160b transmits the communication terminal 150 a transmission request for the certificate set including a device serial number. Upon receiving the request, the communication terminal 150 further transmits a similar request to the CA mirror server 410. In response, the mirror server 410 reads the certificate set corresponding to the specified device serial number from the storage and transmits the certificate to the communication terminal 150. In turn, the communication terminal 150 transmits the certificate set to the factory terminal 160b in response to the transmission request from the factory terminal 160b. The factory terminal 160b transmits the image forming device 100 the certificate set that has been received from the communication terminal 150, and it is the same operation as in the preferred embodiment during which the above certificate set is installed as an individual certificate set as indicated by an arrow IV. Upon receiving the response from the image forming device 100 for the certificate installation request, the factory terminal 160b reports the response to the communication terminal 150, but does not set the writing completion flag. The storage content at the certificate management device 400 is overwritten during the mirroring operation even if the writing completion flag is set. However, it is feasible to store the writing completion flag in the memory area that is not mirrored.

The certificate management device 400 periodically deletes the certificate sets that have been written in the communication devices. For example, if the certificate sets are issued for the daily manufactured devices, since it is assumed that the more-than-one-day old certificate sets have been already installed in the produced communication devices, the certificate sets are selected for deletion based upon the above criterion even without the use of the writing completion flag. The certificate sets that have been deleted at the certificate management device 400 are also deleted at the CA mirror server 410 during the mirror operation. If it is desired to store the certificate sets issued by the certificate management device 400, the certificate sets are moved to a storage area where it is not mirrored in the CA mirror server 410.

In the above process, a necessary number of the certificate sets containing the device serial numbers is issued as identification information by the certificate management device 400. The communication terminal 150 obtains the issued certificates and installs them on the produced communication devices including the image forming devices 100, 110 or the intermediate device 101 via the factory terminal 160. In the above described alternative embodiments, the similar effects are also obtained as described with respect to the preferred embodiment. It should be also mentioned that other alternative embodiments or methods that had been described with respect to the preferred embodiments are also applicable to the currently described alternative embodiments. Based upon the certificate obtaining and installing methods, software programs, storage media for storing the software programs, apparatuses and systems, it is harder to manipulate the communication devices to pretend as an impostor. Furthermore, the current invention also reduces the undesirable effect on security even in the unlikely event that the digital certificates are compromised. Thus, the communication system and the remote management system with the communication devices that have been manufactured by the above described features provide highly secured systems.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

1. A method of obtaining a digital certificate for communication devices, comprising the steps of:
transmitting identification information of a communication device in a digital certificate request to a digital certificate management device for obtaining the digital certificate to be installed in the communication device;
generating the digital certificate including the identification information; and
receiving the digital certificate from the digital certificate management device in response to the request.

2. method of obtaining a digital certificate for communication devices, comprising the steps of:
transmitting identification information on a predetermined communication device in a digital certificate request to a digital certificate management device for obtaining the digital certificate to be installed in the communication device;
generating the digital certificate including the identification information;
receiving the digital certificates from the digital certificate management device in response to the digital certificate request; and
installing the digital certificate in memory of the communication device as identified by the identification information in the digital certificate.

3. The method of obtaining a digital certificate for communication devices according to claim 2 further comprising an additional step of obtaining the identification information in a production management device from a production plan prior to said transmitting the digital certificate request.

4. The method of obtaining a digital certificate for communication devices according to claim 2 wherein the identification information is available from the communication device, the identification information being scanned via a scanner into a certificate installation device, the certificate installation device installing the digital certificate in memory of the communication device as identified by the identification information in the digital certificate and the scanned identification information.

5. The method of obtaining a digital certificate for communication devices according to claim 2 wherein the identification information on a predetermined set of the communication devices to be produced during a predetermined period is transmitted in a digital certificate request to a digital certificate management device, the digital certificates corresponding to the predetermined set of the communication devices being stored in an installation device, the certificate installation device installing each of the digital certificates in memory of a corresponding one of the communication devices as identified by the identification information in the digital certificate.

6. The method of obtaining a digital certificate for communication devices according to claim 5 wherein the predetermined period includes a day, a week and a month.

7. The method of obtaining a digital certificate for communication devices according to claim 2 further comprising an additional step of setting a completion flag indicative of successfully installing the digital certificate in the communication device upon successfully completing said installing step.

8. The method of obtaining a digital certificate for communication devices according to claim 2 further comprising an additional step of deleting the digital certificate upon successfully completing said installing step.

9. The method of obtaining a digital certificate for communication devices according to claim 2 further comprising an additional step of deleting the digital certificate after a predetermined time.

10. The method of obtaining a digital certificate for communication devices according to claim 2 wherein said installing step takes place in a factory where the communication device is assembled.

11. A digital certificate obtaining device for a communication device, comprising:
a transmitting unit for transmitting identification information of the communication device in a digital certificate request to a digital certificate management device for obtaining a digital certificate to be installed in the communication device; and
a receiving unit for receiving the digital certificate including the identification information from the digital certificate management device in response to the request.

12. A digital certificate obtaining device for a communication device, comprising:
a transmitting unit for transmitting identification information of the communication device in a digital certificate request to a digital certificate management device for obtaining a digital certificate to be installed in the communication device; and
a receiving unit for receiving the digital certificate including the identification information from the digital certificate management device in response to the request; and
an installing unit connected to said receiving unit for installing the digital certificate in memory of the communication device as identified by the identification information in the digital certificate.

13. The digital certificate obtaining device for a communication device according to claim 12 further comprising an information obtaining means for obtaining the identification information in a production plan from a production management device, said transmitting unit transmitting the obtained identification information in the digital certificate request.

14. The digital certificate obtaining device for a communication device according to claim 12 wherein the identification information is available from the communication device, the digital certificate obtaining device further comprising a scanner for scanning the identification information, said installing unit installing the digital certificate in memory of the communication device as identified by the identification information in the digital certificate and the scanned identification information.

15. The digital certificate obtaining device for a communication device according to claim 12 wherein said transmitting unit further comprises a first means for transmitting the identification information on a predetermined set of the communication devices to be produced during a predetermined period in the digital certificate request to a digital certificate management device, said receiving unit further comprising a memory for storing the digital certificates corresponding to the predetermined set of the communication devices, said installing unit installing each of the digital certificates in a corresponding one of the communication devices as identified by the identification information in the digital certificates.

16. The digital certificate obtaining device for a communication device according to claim 15 wherein the predetermined period includes a day, a week and a month.

17. The digital certificate obtaining device for a communication device according to claim 12 further comprising a completion flag indicative of successfully installing the digital certificate in the communication device.

18. The digital certificate obtaining device for a communication device according to claim 12 wherein said installing unit deletes the digital certificate upon successfully installing the digital certificate.

19. The digital certificate obtaining device for a communication device according to claim 12 wherein said installing unit deletes the digital certificate after a predetermined time.

20. The digital certificate obtaining device for a communication device according to claim 12 wherein said installing unit is located in a factory where the communication device is assembled.

21. A digital certificate handling system for a communication device, comprising:
a digital certificate management device for generating the digital certificates each including identification information of respective one of the communication devices in response to a digital certificate request; and
a certificate obtaining device connected to said digital certificate management device for obtaining the digital certificates, said certificate obtaining device further comprising an issue request transmitting unit for transmitting the identification information of the communication devices in the digital certificate request to said digital certificate management device, said certificate obtaining device further comprising a receiving unit for receiving the digital certificates including the identification information from said digital certificate management device in response to the digital certificate request, said certificate obtaining device further comprising a certificate transmission unit for transmitting the received digital certificates to a certificate installing device where the digital certificates are installed in the communication devices.

22. A digital certificate handling system for a communication device, comprising:
a digital certificate management device for generating the digital certificates each including identification information of respective one of the communication devices in response to a digital certificate request; and
a certificate installing device connected to said digital certificate management device for obtaining and installing the digital certificates, said certificate installing device further comprising an issue request transmitting unit for transmitting the identification information of the communication devices in the digital certificate request to said digital certificate management device, said certificate installing device further comprising a receiving unit for receiving the digital certificates including the identification information from said digital certificate management device in response to the digital certificate request, said certificate installing device further comprising a certificate installing unit for installing the received digital certificates in the communication devices as identified by the identification information in the digital certificates.

23. The digital certificate handling system for a communication device according to claim 22 wherein said certificate installing device further comprises an information obtaining means for obtaining the identification information in a production plan from a production management device, said transmitting unit transmitting the obtained identification information in the digital certificate request.

24. The digital certificate handling system for a communication device according to claim 22 wherein the identification information is available from the communication device, the certificate installing device further comprising a scanner for scanning the identification information, said certificate installing unit installing the digital certificate in memory of the communication device as identified by the identification information in the digital certificate and the scanned identification information.

25. The digital certificate handling system for a communication device according to claim 22 wherein said issue request transmitting unit further comprises a first means for transmitting the identification information on a predetermined set of the communication devices to be produced during a predetermined period in the digital certificate request to said digital certificate management device, said receiving unit further comprising a memory for storing the digital certificates corresponding to the predetermined set of the communication devices, said certificate installing unit installing each of the digital certificates in a corresponding one of the communication devices as identified by the identification information in the digital certificate.

26. The digital certificate handling system for a communication device according to claim 25 wherein the predetermined period includes a day, a week and a month.

27. The digital certificate handling system for a communication device according to claim 22 further comprising a completion flag indicative of successfully installing the digital certificate in the communication device.

28. The digital certificate handling system for a communication device according to claim 22 wherein said certificate installing device deletes the digital certificate upon successfully installing the digital certificate.

29. The digital certificate handling system for a communication device according to claim 22 wherein said certificate installing device deletes the digital certificate after a predetermined time.

30. The digital certificate handling system for a communication device according to claim 22 wherein said certificate installing device is located in a factory where the communication device is assembled.

31. A computer program for controlling a digital certificate management device and a computer for performing the following tasks, the tasks comprising:
transmitting identification information of the communication device in a digital certificate request to a digital certificate management device for obtaining a digital certificate to be installed in the communication device as a transmitting unit; and
receiving the digital certificate including the identification information from the digital certificate management device in response to the request as a receiving unit.

32. A computer program for controlling a digital certificate management device and a computer for performing the following tasks, the tasks comprising:
transmitting identification information of the communication device in a digital certificate request to a digital certificate management device for obtaining a digital certificate to be installed in the communication device; and
receiving the digital certificate including the identification information from the digital certificate management device in response to the request; and
installing the digital certificate in memory of the communication device as identified by the identification information in the digital certificate.

33. The computer program according to claim 32 further comprising an additional task of obtaining the identification information in a production plan from a production management device, the obtained identification information being transmitted in the digital certificate request.

34. The computer program according to claim 32 wherein the identification information is available from the communication device, claim 34 further comprising an additional task of scanning the identification information, the digital certificate being installed in memory of the communication device as identified by the identification information in the digital certificate and the scanned identification information.

35. The computer program according to claim 32 wherein the identification information on a predetermined set of the communication devices to be produced during a predetermined period is transmitted in the digital certificate request to the digital certificate management device, the digital certificates corresponding to the predetermined set of the communication devices being stored, each of the digital certificates being installed in a corresponding one of the communication devices as identified by the identification information in the digital certificates.

36. The computer program according to claim 35 wherein the predetermined period includes a day, a week and a month.

37. The computer program according to claim 32 further comprising an additional task of maintaining in a completion flag indicative of successfully installing the digital certificate in the communication device.

38. The computer program according to claim 32 further comprising an additional task of deleting the digital certificate upon successfully installing the digital certificate.

39. The computer program according to claim 32 further comprising an additional task of deleting the digital certificate after a predetermined time.

40. The computer program according to claim 32 wherein said installing task takes place in a factory where the communication device is assembled.
